(19) United States
(12) Patent Application Publication
(10) Pub. No.: US 2026/0095470 A1
(43) Pub. Date: Apr. 2, 2026

(54) Cybersecurity Breach Prediction

(71) Applicant: CrowdStrike, Inc., Sunnyvale, CA (US)

(72) Inventors: Vitaly Zaytsev, Beaverton, OR (US); Ryan Inghilterra, Carlsbad, CA (US); Joel Robert Spurlock, Portland, OR (US); Michael Avraham Brautbar, Wayland, MA (US); Robert Andrew Molony, Oakland, CA (US)

(73) Assignee: CrowdStrike, Inc., Sunnyvale, CA (US)

(21) Appl. No.: 18/900,779

(22) Filed: Sep. 29, 2024

(51) Int. Cl. H04L 9/40

(52) U.S. Cl. CPC H04L 63/1425; H04L 63/1416; H04L 63/1483

(57) ABSTRACT

Prediction of cybersecurity breaches greatly improves computer functioning. When a client device reports a cybersecurity detection, the cybersecurity detection is compared to true positive cybersecurity detection characteristics. The true positive cybersecurity detection characteristics represent true positive cybersecurity detections that remain after applying a false positive pruning operation. If the cybersecurity detection conforms to the true positive cybersecurity detection characteristics, then the cybersecurity detection may be categorized as true positive and abnormal operation. The false positive pruning operation removes false positive influences to produce a more accurate detection of abnormal/suspicious/malicious computer usage/activity.

### CROSS-REFERENCE TO RELATED APPLICATION

This patent application relates to U.S. application Ser. No. 18/894,372, filed Sep. 24, 2024, entitled “Prediction of False Positive Cybersecurity Detections” (Attorney Docket 20240030US), and incorporated herein by reference in its entirety.

### BACKGROUND

The subject matter described herein generally relates to electrical communications and to computer security and, more particularly, the subject matter relates to monitoring computer behavior.

Cybersecurity breaches are a problem in the cybersecurity industry. Cyber attackers are constantly evolving and obfuscating their malicious schemes. Legitimate software services are also constantly evolving. The cybersecurity industry is thus always striving to improve threat detection in a very dynamic environment. Consequently, many false positive cybersecurity detections are generated, and these false positive cybersecurity detections waste significant computer and human resources and electrical energy.

### SUMMARY

Accurate detection or prediction of cybersecurity breaches compensates for false positive computer behavior. False positive cybersecurity detections actually describe normal computer behavior. A cybersecurity service uses advanced graphical techniques, a false positive pruning operation, and machine learning to produce faster and more accurate detections of abnormal computer behavior. Multiple sources of data are used to construct layered views of computer behavior. The false positive pruning operation removes common patterns of false positive computer behavior and/or recurring false positive cybersecurity detections. The false positive pruning operation thus identifies and isolates true positive computer behaviors that remain after the false positive computer behaviors are pruned. Machine learning is then more accurately trained using only true positive computer behaviors representing abnormal computer operations. Because the machine learning is more accurately trained, the machine learning also more accurately predicts true positive computer behaviors that indicate a cybersecurity breach. Hardware and software resources are not wasted analyzing false positives, and much less electrical energy is consumed.

### BRIEF DESCRIPTION OF THE SEVERAL VIEWS OF THE DRAWINGS

The features, aspects, and advantages of cybersecurity breach predictions are understood when the following Detailed Description is read with reference to the accompanying drawings, wherein:

FIGS. 1-3 illustrate some examples of predicting cybersecurity breaches;

FIGS. 4-8 illustrate some examples of multi-modal input data from multiple sources;

FIGS. 9-13 illustrate some examples of a multi-layered graph;

FIG. 14 illustrates some examples of layer aggregation and anomaly detection;

FIGS. 15-18 illustrate some examples of false positive pruning;

FIGS. 19-20 illustrate some examples of profile breach detection;

FIG. 21 illustrates some examples of machine learning;

FIG. 22 illustrates some examples of false positive prediction;

FIGS. 23-25 illustrate some examples of detection sourcing;

FIG. 26 illustrates some examples of local endpoint prediction;

FIGS. 27-29 illustrate examples of methods or operations that generate cybersecurity breach predictions; and

FIG. 30 illustrates a more detailed example of the operating environment.

### DETAILED DESCRIPTION

False positives are a concern in the cybersecurity industry. As we all know, nearly every day there is another cybersecurity hack that steals account passwords, business data, and personal information. Email inboxes often contain phishing emails, malicious website links, and virus attachments. Text messages may also contain malicious links and content. Indeed, hackers are always trying new schemes to steal information. Cybersecurity services, though, can protect computers, smartphones, and other devices from cyberattacks. Cybersecurity services detect computer activities and behaviors that may indicate suspicious or even malicious operation. Unfortunately, though, many computer activities and behaviors are later determined to be benign. That is, a cybersecurity service may receive thousands of reports of supposedly suspicious computer activities and behaviors. Much time and computer resources are then spent analyzing these thousands of reports. A high proportion of the reports, though, are determined to be false positives. These false positives, in plain words, are false alarms. The supposedly suspicious computer activities and behaviors are actually determined to be normal operation. Time, computer resources, and electrical energy were thus wasted in analyzing these thousands of false positive reports.

Some examples relate to compensating for false positives. A cybersecurity service uses advanced graphical techniques, a false positive pruning operation, and machine learning to produce faster and more accurate detections of abnormal computer behavior. Multiple sources of data are used to construct an attack graph having multiple, layered views of computer behavior. The false positive pruning operation is applied to the graphical data that represents the attack graph. The false positive pruning operation removes false positive computer behavior from the graphical data. The false positive pruning operation thus identifies and isolates true positive computer behaviors that remain after the false positive computer behaviors are pruned. The graphical data, in other words, mostly or solely represents true positive computer behaviors that only describe suspicious/malicious/abnormal operation. Machine learning is then more accurately trained using only the graphical data representing the true positive computer behaviors. Because the machine learning is more accurately trained, the machine learning also more accurately predicts true positive computer behaviors that indicate a cybersecurity breach. Hardware and software resources are not wasted analyzing false positives, and much less electrical energy is consumed.

Cybersecurity breach predictions will now be described more fully hereinafter with reference to the accompanying drawings. Cybersecurity breach predictions, however, may be embodied in many different forms and should not be construed as limited to the examples set forth herein. These examples are provided so that this disclosure will be thorough and complete and fully convey cybersecurity breach predictions to those of ordinary skill in the art. Moreover, all the examples of cybersecurity breach predictions are intended to encompass both structural and functional equivalents thereof. Additionally, it is intended that such equivalents include both currently known equivalents as well as equivalents developed in the future (i.e., any elements developed that perform the same function, regardless of structure).

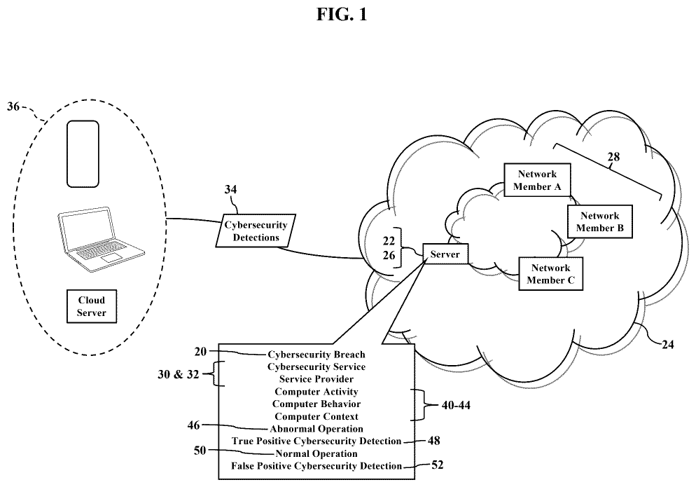

FIGS. 1-3 illustrate some examples of predicting a cybersecurity breach 20. A computer system 22 operates in a cloud computing environment 24. FIG. 1 illustrates the computer system 22 as a server 26. The computer system 22, though, may be any processor-controlled device, as later paragraphs will explain. In this example, the server 26 communicates via the cloud computing environment 24 (e.g., public Internet, private network, and/or hybrid network) with other servers, devices, computers, or other networked members 28 operating within, or affiliated with, the cloud computing environment 24. The cloud computing environment 24 provides a digital cybersecurity service 30 on behalf of a service provider 32. The digital cybersecurity service 30 receives reports of cybersecurity detections 34 from customers and users (such as client devices 36). The cloud computing environment 24 inspects and analyzes the cybersecurity detections 34 to predict unauthorized attempts to access data, applications, devices, networks, and other cybersecurity breaches 20.

The cybersecurity breaches 20 are a recurring problem. Cybersecurity breaches consistently make news headlines, as nearly every day another cyberattack is discovered. Indeed, cyberattacks are increasingly sophisticated and always morphing. Cybersecurity breaches are thus difficult to identify and difficult to stop.

The digital cybersecurity service 30, though, predicts the cybersecurity breaches 20. When the cloud computing environment 24 receives the cybersecurity detection 34, the nodal networked members 28 inspect and analyze the cybersecurity detection 34. While there may be many networked members 28 of the cloud computing environment 24, FIG. 1 illustrates a simple example using the server 26. That is, when the cloud computing environment 24 receives the cybersecurity detection 34, the nodal networked members 28 may forward the cybersecurity detection 34 to the server 26. The server 26 is programmed to predict the cybersecurity breach 20, based on the computer activity 40, computer behavior 42, and/or computer context 44 associated with the cybersecurity detection 34. If the associated or surrounding computer activity 40, computer behavior 42, and/or computer context 44 is/are determined to be abnormal operation 46, then the cybersecurity detection 34 is a true positive cybersecurity detection 48. The cybersecurity detection 34 is a legitimate report of suspicious, or even malicious, computer activity/behavior/context 40/42/44. If, however, the computer activity/behavior/context 40/42/44 is/are determined to be benign, normal operation 50, then the cybersecurity detection 34 is a false positive cybersecurity detection 52. The cybersecurity detection 34, in plain words, is a false alarm.

The false positive cybersecurity detection 52 greatly wastes resources. The cybersecurity service 30 dedicates and prioritizes much hardware resources (e.g., processor and memory) and much network resources (e.g., bandwidth and packet traffic) to analyzing the cybersecurity detections 34 for the cybersecurity breaches 20. The cybersecurity service 30 also consumes much electrical power when analyzing the cybersecurity detections 34. When many of the cybersecurity detections 34, though, are determined to be normal operation 50, the cybersecurity service 30 has thus wasted much hardware, network, and power resources on the false positive cybersecurity detections 52. Wrong security alerts triggered by benign metadata and other computer activity/behavior/context 40/42/44 are thus a concern in the cybersecurity industry.

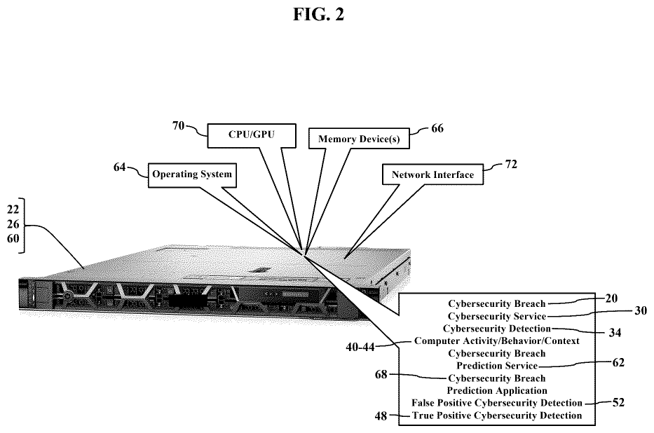

As FIG. 2 illustrates, though, the server 26 is programmed to predict the cybersecurity breaches 20. FIG. 2 illustrates the server 26 as a rack server 60, which is commonly installed in server rooms and in server farms. The server 26/60 is programmed to provide a cybersecurity breach prediction service 62, perhaps as a module, component, or subservice of the cybersecurity service 30. The server 26 predicts the cybersecurity breach 20, based on the computer activity/behavior/context 40/42/44 associated with the cybersecurity detection 34. The server 26 stores and executes an operating system 64 in a memory device 66. The server 26 also stores a cybersecurity breach prediction application 68 in the memory device 66. The server 26 has a hardware processor with cores 70 (illustrated as “CPU/GPU”) that reads and executes the operating system 64 and the cybersecurity breach prediction application 68. The server 26 also has network interfaces 72 to multiple communications networks (such as the cloud computing environment 24 illustrated in FIG. 1), thus allowing bi-directional communications with other networked devices and services. The cybersecurity breach prediction application 68 has programming code or instructions that cause the server 26 to perform operations, such as predicting whether the cybersecurity detection 34 is the false positive cybersecurity detection 52, the true positive cybersecurity detection 48, and/or the cybersecurity breach 20.

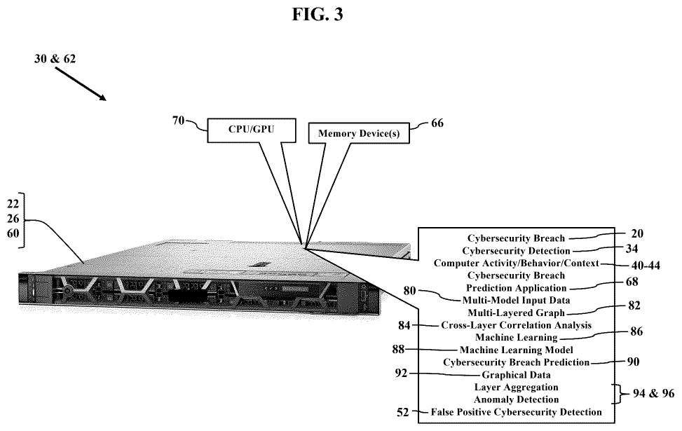

FIG. 3 illustrates examples of the cybersecurity breach prediction service 62. The computer system 22 (again illustrated as the rack server 60) provides the cybersecurity service 30 and/or the cybersecurity breach prediction service 62. The cybersecurity breach prediction application 68 may cause or instruct the server 26/60 to integrate multi-modal input data 80 from multiple sources. The multi-modal input data 80 provides a richer and more accurate picture of attacker activities (e.g., the computer activity/behavior/context 40/42/44). The cybersecurity service 30, and/or the cybersecurity breach prediction service 62, generates a multi-layered graph 82 using the multi-modal input data 80, thereby representing data across different security domains (such as operating system processes, users, devices, identities, cloud activity events, and client/agent behavioral events) (e.g., the computer activity/behavior/context 40/42/44). Because the cybersecurity breach prediction service 62 generates the multi-layered graph 82 having multiple layers, the cybersecurity breach prediction service 62 may conduct one or more cross-layer correlation analyses 84. The cybersecurity breach prediction service 62 may stack/overlay and/or peel away individual data layers from the multi-layered graph 82, thereby discovering correlations for events from different domains. The cybersecurity breach prediction service 62 may build relationships between graphical nodes across different layers and identify potential pathways for attacker movement. Relationships within layers, for example, may reveal intralayer relationships between entities (such as all processes executed by the same user). Relationships between layers, as more examples, may reveal interlayer relationships between entities across layers. For instance, a process execution event on a device (such as Layer 1) connects to the user who initiated the process (such as Layer 2). As another example, a compromised user account or remote IP address (such as Layer 1) may be linked to suspicious cloud activity (Layer 2) involving unauthorized access attempts.

The cybersecurity services 30 and/or 62 may also utilize machine learning 86. The cybersecurity breach prediction service 62 may use a machine learning model 88 to generate a cybersecurity breach prediction 90. The cybersecurity breach prediction service 62 incorporates a time aware graph structure and graph entity attributes (such as graphical data 92 representing the multi-layered graph 82) into the model learning process. The cybersecurity breach prediction service 62 may thus analyze the relationships between entities (such as users, devices, IP addresses, and cloud workloads) in the time aware graph structure and identify how these relationships evolve over time. The cybersecurity breach prediction service 62 may thus detect subtle changes indicative of ongoing cybersecurity breaches 20.

The cybersecurity services 30 and/or 62 may also utilize layer aggregation 94 and anomaly detection 96. One or more layer aggregation algorithms combine information from one or more different layers into a cohesive, aggregated representation. The cybersecurity service 30 and/or the cybersecurity breach prediction service 62 may feed this cohesive, aggregated representation into an anomaly classifier to identify obvious outliers. Once the outliers are identified (such as false positive cybersecurity detections 52), the cybersecurity services 30 and/or 62 may reduce incident size by pruning or removing the false positive cybersecurity detections 52. The cybersecurity breach prediction application 68, for example, may prune the false positive cybersecurity detections 52 from the same device(s), and/or from different device(s), and/or from same/different cloud entities that is/are specific to a user/customer/entity environment.

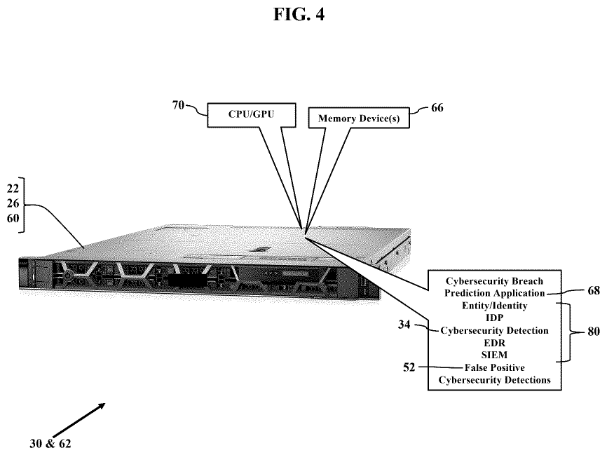

FIGS. 4-8 illustrate some examples of the multi-modal input data 80 from the multiple sources. The computer system 22 (again illustrated as the rack server 60) receives the multi-modal input data 80 via a communications network (such as the cloud computing environment 24 or other communications network, as illustrated in FIG. 1). The server 26/60, for example, may receive identity/entity data from an identity provider (or IDP) system. The server 26/60 may receive endpoint detection events (such as operating system events, machine data, EDR, and other cybersecurity detections 34) sent from, or associated with, the client device 36 (illustrated in FIG. 1). The server 26/60 may receive extended detection and response (or XDR) data sent from email servers, network servers, and/or cloud service servers associated with the client device 36. The server 26/60 may receive security information and event management (or SIEM) data sent from, or associated with, the client device 36 and/or the cloud computing environment 24. The server 26/60 may thus receive client/network events, network traffic, cloud activity logs, identity protection events, endpoint behavioral data, and other data from multiple sources that provides a rich and accurate picture of device/network/attacker activities.

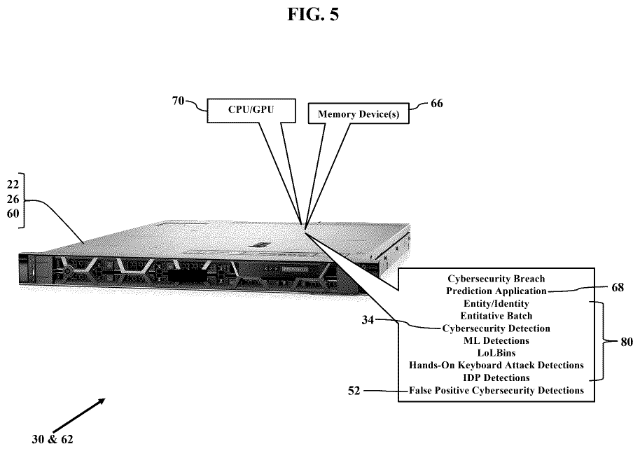

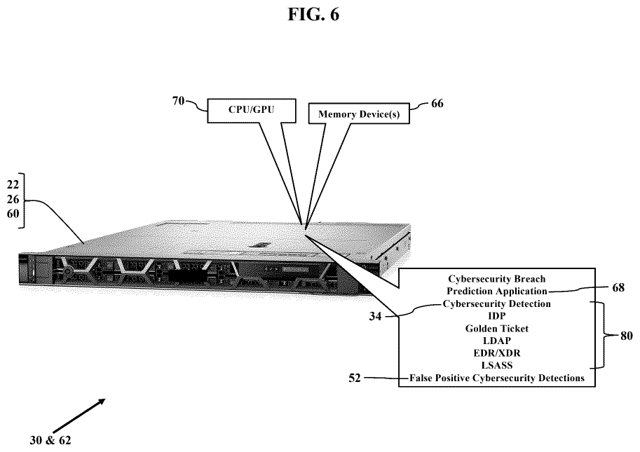

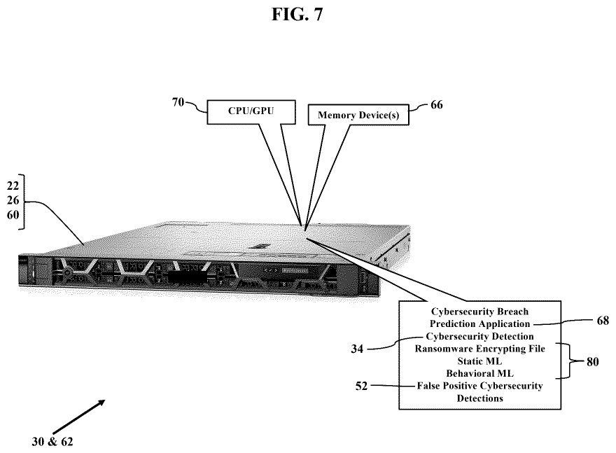

FIGS. 5-7 illustrate more examples of the multi-modal input data 80. Because the cybersecurity services 30 and/or 62 may receive many different input data 80 from many different source systems, the cybersecurity services 30 and/or 62 may logically group and/or subgroup the cybersecurity detections 34 and/or other multi-modal input data 80 for refined predictions. The cybersecurity service 30, for example, may logically group the cybersecurity detections 34 and other multi-modal input data 80 according to the entity/identity, thus generating a corresponding entitative batch. The cybersecurity detections 34, as examples, may be grouped by detection type and/or by entity type (such as IDP detections, static machine learning (or ML) detections, and behavioral ML detections). The cybersecurity detections 34, as more examples, may be grouped by user, customer, product, or company source/type. Moreover, the cybersecurity service 30 may further logically subgroup the cybersecurity detections 34 within the entitative batch. FIG. 5, as examples, illustrates the cybersecurity detections 34 grouped according to malware static/behavioral detections, ML detections, Living off the land binaries (or Lolbins), Hands-on Keyboard attack detections, and IDP detections. FIG. 6, as more examples, illustrates the multi-modal input data 80 grouped according to the identity provider (or IDP), such as Golden Ticket Attack (e.g., using a golden ticket to request access and/or detecting abusive KERBEROS^{®} protocol usage), IDP LDAP Reconnaissance Account Discovery (e.g., a user executed a suspicious LDAP search enumerating AD accounts and/or cases where user executed a suspicious LDAP search request commonly performed by known reconnaissance attack tools, such as Bloodhound or Impacket), and EDR/XDR cybersecurity detections 34 (such as mimikatz hack tool detection, which detects the Local Security Authority Subsystem Service (or LSASS) process that was accessed from the mimikatz hack tool, such as by opening a handle to LSASS for credential dumping). FIG. 7, as still more examples, illustrates the multi-modal input data 80 grouped according to the Ransomware Encrypting File detection (e.g., detecting a file with a known ransomware extension), static ML detection (e.g., machine learning detection with high-confidence results), behavioral ML detection (e.g., detection of a process that launched and meets a behavioral ML algorithm's high confidence threshold). By entitatively batching the multi-modal input data 80, each entitative batch may reveal finer and more accurate false positive cybersecurity detection characteristics that reveal the false positive cybersecurity detections 52. The entitative batching may thus result in more accurate profiling (such as extracted features for training of the machine learning model 88 as illustrated in FIG. 3).

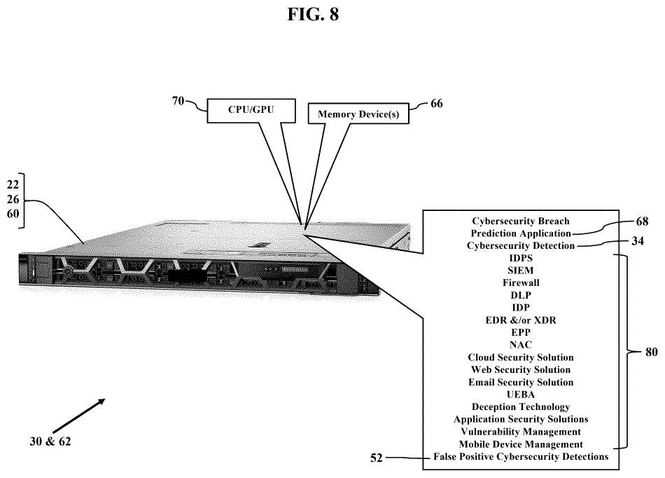

FIG. 8 illustrates even more examples of entitative batching. The cybersecurity services 30 and/or 62 may logically group and/or subgroup the cybersecurity detections 34 and/or the multi-modal input data 80 according to even more categories of the entitative batches. A first category, for example, may include Intrusion Detection and Prevention Systems (or IDPS). These products and/or services include Network Intrusion Detection Systems (or NIDS), Host Intrusion Detection Systems (or HIDS), Intrusion Prevention Systems (or IPS), Unified Threat Management (or UTM), Next-Generation Intrusion Prevention Systems (or NGIPS), and many others. These products and/or services may generate/send/report the cybersecurity detections 34 and other multi-modal input data 80, such as signature-based detections, anomaly-based detections, protocol anomaly detections, zero-day exploit detections, network-based attacks (e.g., port scans, brute force attacks), host-based attacks (e.g., privilege escalation), Denial of Service (or DoS) attacks, backdoor detections, buffer overflow attacks, and SQL injection attacks.

The cybersecurity service 30 may group according to Security Information and Event Management (or SIEM). These products and/or services include traditional SIEM systems, Next-Generation SIEM (NG SIEM), cloud-based SIEM, managed SIEM services, and SIEM with user and enrity behavior analytics (or UEBA) integration. These products and/or services may generate/send/report the cybersecurity detections 34 and other multi-modal input data 80, such as anomalous network traffic, insider threats, behavioral analytics, advanced threat detection, and compliance monitoring.

The cybersecurity service 30 may group according to firewall(s). These products and/or services include traditional network firewalls, Next-Generation Firewalls (or NGFW), Web Application Firewalls (or WAF), cloud firewalls, and Unified Threat Management (or UTM) Firewalls. These products and/or services may generate/send/report the cybersecurity detections 34 and other multi-modal input data 80, such as port scanning detections, intrusion detection/prevention, unusual protocol usage detections, IP spoofing, DDoS attacks, malicious payloads, outbound traffic anomalies, application layer attacks, and VPN exploits.

The cybersecurity service 30 may group according to Data Loss Prevention (or DLP). These products and/or services include endpoint DLP solutions, network DLP solutions, cloud DLP solutions, email DLP solutions, and integrated DLP platforms. These products and/or services may generate/send/report the cybersecurity detections 34 and other multi-modal input data 80, such as sensitive data transfer detections, email leakage, endpoint data leakage, cloud data protection, file sharing monitoring, removable media control, data masking and encryption violations, and database activity monitoring.

The cybersecurity service 30 may group according to Identity Detection and Protection (or IDP). These products and/or services include Identity and Access Management (or IAM) Systems, Multi-Factor Authentication (or MFA) Solutions, Privileged Access Management (or PAM), Single Sign-On (or SSO) Solutions, and Identity Governance and Administration (or IGA). These products and/or services may generate/send/report the cybersecurity detections 34 and other multi-modal input data 80, such as the Golden ticket attacks, LDAP reconnaissance, Pass-the-Hash (or PtH) attacks, password spraying, brute force attacks, privileged account abuse, account hijacking, user behavior anomalies, single sign-on (or SSO) abuse, and multi-factor authentication (MFA) bypass.

The cybersecurity service 30 may group according to Endpoint Detection and Response (or EDR) and Extended Detection and Response (or XDR). These products and/or services include EDR platforms, XDR solutions, Endpoint Protection Platforms (or EPP), and Next-Generation Antivirus (or NGAV). These products and/or services may generate/send/report the cybersecurity detections 34 and other multi-modal input data 80, such as ransomware, fileless malware, advanced persistent threats (or APTs), credential dumping, lateral movement, persistence mechanisms, data exfiltration, command and control (or C2) communication, privilege escalation, parasitic viruses, coin miners, backdoors, and trojans/downloaders.

The cybersecurity service 30 may group according to the Endpoint Protection Platform (or EPP). These products and/or services include antivirus software, antimalware solutions, exploit prevention tools, application whitelist/blacklist, and Host Intrusion Prevention Systems (or HIPS). These products and/or services may generate/send/report the cybersecurity detections 34 and other multi-modal input data 80, such as antivirus/malware detections, behavioral analysis, exploit prevention, file integrity monitoring, application whitelisting/blocking, script control detections, and web based threats.

The cybersecurity service 30 may group according to Network Access Control (or NAC). These products and/or services include network admission control, endpoint compliance checking, guest access management, IoT security solutions, and other bring-your-own-device (or BYOD) management solutions. These products and/or services may generate/send/report the cybersecurity detections 34 and other multi-modal input data 80, such as unauthorized device detections, endpoint compliance checks, network segmentation, guest access monitoring, BYOD management, IoT device monitoring, anomalous network access, policy violations, quarantine management, and access control list (or ACL) alerts.

The cybersecurity service 30 may group according to the cloud security solution. These products and/or services include Cloud Access Security Brokers (or CASBs), Cloud Security Posture Management (or CSPM), Cloud Workload Protection Platforms (or CWPP), Cloud Infrastructure Entitlement Management (or CIEM), and Cloud-Native Security Platforms (or CNSP). These products and/or services may generate/send/report the cybersecurity detections 34 and other multi-modal input data 80, such as unauthorized data transfers to/from cloud services, monitoring and securing data in cloud storage, compliance with cloud configurations, protecting cloud workloads, cloud entitlements and permissions, shadow IT detection, cloud service misconfigurations, malicious cloud activity detection, API abuse detection, and data residency violations.

The cybersecurity service 30 may group according to the web security solution. These products and/or services include Secure Web Gateways (or SWG), URL filtering systems, content filtering systems, web application security platforms, and secure socket layer (or SSL) inspection tools. These products and/or services may generate/send/report the cybersecurity detections 34 and other multi-modal input data 80, such as malicious website access, URL filtering, content filtering, web-based threats, script injection, browser exploitation, phishing websites, drive-by downloads, inappropriate content access, and SSL inspection.

The cybersecurity service 30 may group according to the email security solution. These products and/or services include email security gateways, anti-spam filters, phishing detection systems, email encryption solutions, and email threat protection platforms. These products and/or services may generate/send/report the cybersecurity detections 34 and other multi-modal input data 80, such as phishing emails, spam detection, malware attachments, email spoofing, data leakage through email, business email compromise (or BEC), malicious links, impersonation attacks, email account takeover, and advanced persistent threats (or APTs) via email.

The cybersecurity service 30 may group according to the User and Entity Behavior Analytics (or UEBA). These products and/or services include email behavioral analytics platforms, anomaly detection systems, insider threat detection solutions, user activity monitoring tools, and entity behavior profiling systems. These products and/or services may generate/send/report the cybersecurity detections 34 and other multi-modal input data 80, such as user behavior anomalies, entity behavior analysis, insider threats, account compromise detection, unusual access patterns, privilege abuse, lateral movement detection, data exfiltration activities, suspicious login attempts, and abnormal file access.

The cybersecurity service 30 may group according to deception technology. These products and/or services include honeypots, honeytokens, deception platforms, decoy systems, and deception grids. These products and/or services may generate/send/report the cybersecurity detections 34 and other multi-modal input data 80, such as unauthorized access to decoys, interaction with honeytokens, lateral movement detection, credential theft attempts, malicious reconnaissance, fake service interactions, decoy network communications, suspicious activity in decoy environments, anomalous user behavior on decoys, and exploitation attempts on decoy systems.

The cybersecurity service 30 may group according to the application security solution. These products and/or services include Static Application Security Testing (SAST), Dynamic Application Security Testing (DAST), Runtime Application Self-Protection (RASP), Interactive Application Security Testing (IAST), and Application Vulnerability Scanners. These products and/or services may generate/send/report the cybersecurity detections 34 and other multi-modal input data 80, such as code vulnerabilities, runtime exploits, application attacks, input validation failures, security misconfigurations, SQL injection attacks, cross-site scripting (XSS), insecure API usage, authentication bypass, and session hijacking.

The cybersecurity service 30 may group according to vulnerability management. These products and/or services include vulnerability scanners, Patch Management Systems, Configuration Management Tools, Compliance Management Systems, and Penetration Testing Tools. These products and/or services may generate/send/report the cybersecurity detections 34 and other multi-modal input data 80, such as vulnerability detection, unpatched software, security misconfigurations, compliance violations, weak password policies, outdated software, open ports, insecure configurations, unprotected sensitive data, and end-of-life software checks.

The cybersecurity service 30 may group according to Mobile Device Management (or MDM). These products and/or services include Mobile Security Solutions, Mobile Threat Defense (MTD), Mobile Application Management (MAM), Mobile Content Management (MCM), and Unified Endpoint Management (UEM). These products and/or services may generate/send/report the cybersecurity detections 34 and other multi-modal input data 80, such as mobile malware, unauthorized mobile access, data leakage from mobile devices, compliance with mobile policies, rooted/jailbroken devices, malicious mobile applications, device location tracking, mobile phishing attempts, insecure mobile configurations, and network attacks targeting mobile devices.

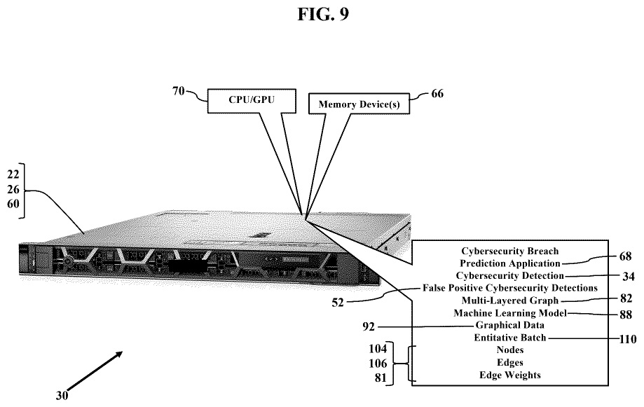

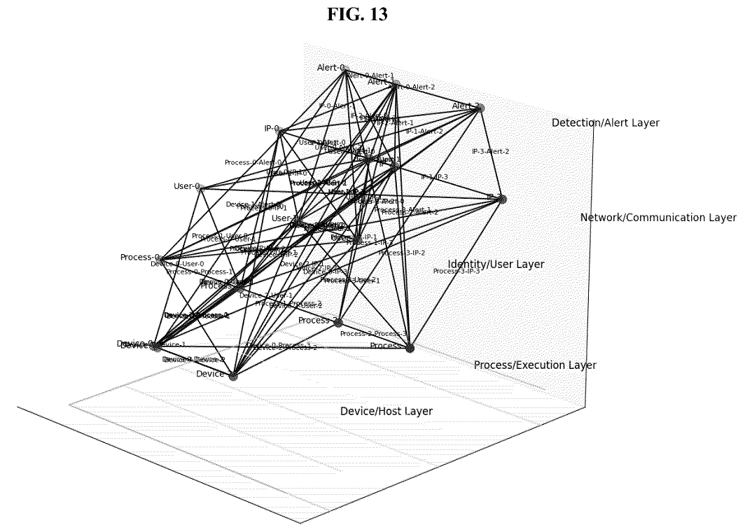

FIGS. 9-13 illustrate examples of the multi-layered graph 82. The server 26/60 generates the multi-layered graph 82 using the graphical data 92 (as illustrated with reference to FIG. 3). The graphical data 92 may represent the multi-modal input data 80 sourced from the multiple sources (as explained with reference to FIGS. 4-8). As a common example, the server 26/60 may be programmed (perhaps by the cybersecurity breach prediction application 68, illustrated in FIG. 3) to represent the graphical data 92 as a webpage. The server 26/60 may send the webpage to client destinations for download and display. The server 26/60, however, may also interface with a display device (such as a monitor or display screen), thus allowing the server 26/60 to process the graphical data 92 for display as the multi-layered graph 82. The cybersecurity breach prediction application 68, for example, may also have a user interface, thus allowing a user to interface with the multi-layered graph 82, input queries, and see visual results.

The machine learning model 88 may be trained using the graphical data 92. The graphical data 92, as another example, may represent the entitative batch(es) 110 of the cybersecurity detections 34. The graphical data 92 has nodes 104 and edges 106, and the edges 106 may be weighted with edge weights 81 representing characteristics associated with the entity/entities. The cybersecurity service 30 (such as the server 26) may train the machine learning model 88 using the graphical data 92 representing the entitative batch(es) 110, with the graphical edges 106 weighted with the edge weights 81 representing characteristics associated with the entity.

The edge weights 81, for example, may represent a detection frequency. The cybersecurity service 30 may analyze how frequently each cybersecurity detection 34 occurs across one or multiple entities (such as, for example, different devices, different software processes, and/or different users/groups). If the cybersecurity detection 34 frequently occurs across many entities in a consistent pattern, for example, this pattern may indicate a strong relationship between those entities. For example, if the software process svchost.exe is frequently detected as suspicious across multiple devices (e.g., Device-1, Device-2, Device-3), the edges 106 connecting these devices to svchost.exe may be assigned higher edge weights 81.

The edge weights 81, as more examples, may represent time decay factors. The edge weights 81 may be adjusted by incorporating a time decay factor that gives more importance to recent cybersecurity detections 34. The time decay factor ensures that the graphical data 92 reflects the most current and relevant data. For example, a cybersecurity detection 34 that occurred recently might be weighted more heavily than a historical cybersecurity detection 34 that occurred several weeks ago, making the edge 106 more significant in the current context.

The edge weights 81, as still more examples, may represent batch statistics. The cybersecurity service 30, for example, may group or batch the cybersecurity detections 34 based on relationships (e.g., all detections related to a specific user or device within a time frame). Statistical analysis is then performed to identify commonalities and outliers. The edge 106 for each cybersecurity detection 34 may be derived from this statistical analysis, where cybersecurity detections 34 that show consistent patterns within the entitative batch 110 receive higher edge weights 81. For example, if several devices in the same network segment show similar detection patterns over time, the edges 106 between these devices and the associated detections 34 are weighted more heavily.

The edge weights 81, as yet more examples, may represent intra/inter-batching. The edge weights 81 may be assigned differently depending on whether the entitative relationship is within the same batch 110 (i.e., intra-batch) or across different batches 110 (i.e., inter-batch). Intra-batch edges 106 might have a higher edge weight 81 if the detections 34 within the batch 110 are highly correlated. For example, if Process-A and Process-B are both frequently detected on the same set of devices within a short time window, the edge 106 between them in the graph will have a higher edge weight 81.

The cybersecurity service 30 may adjust the edge weights 81 during prediction and during operation. The edge weights 81, for example, may be dynamically adjusted in real-time as new data comes in. The edge weights 81, as another example, may be dynamically adjusted based on historical data (such as the previous hours/days). The edge weights 81 may thus reflect the current state, or an historical state, of the cybersecurity system 30. For example, as new detections 34 occur, the cybersecurity system 30 may update the graphical data 92 with the most recent information. The frequency and timing of these new detections 34 may influence the edge weights 81. If a detection pattern that was observed during training suddenly spikes in frequency, for example, the associated edges weights 81 are increased. For example, if svchost.exe suddenly start exhibiting unusual behavior across multiple devices, the edges 106 connecting these devices to svchost.exe are assigned higher edges weights 81.

The cybersecurity service 30, as more examples, may adjust the edge weights 81 based on the activity/behavior/context 40-44 (illustrated in FIGS. 1-3). If, for example, a detection 34 deviates significantly from the normal operation 50 learned during training, this deviation could indicate an anomaly. The edge weights 81 may be adjusted accordingly to reflect the increased importance of this relationship in identifying potential false positives or true positives. For example, if a normally benign process suddenly triggers new detection 34 (alert), the edge 106 between this process and the detection node may be assigned a higher edges weight 81.

The edge weights 81, as more examples, may represent the activity/behavior/context 40-44. The cybersecurity service 30 integrate current and/or historical activity/behavior/context 40-44 to refine the edge weights 81. For example, if a process has a known history of triggering false positives in specific contexts 44, the edge weights 81 may be adjusted down to reduce the likelihood of FPs. For example, if Process-C has a history of benign behavior when triggered by User-A, the edge weight 81 between Process-C and detections related to User-A might be reduced.

Also, instead of adding a new node for a detection group, the cybersecurity service 30 may create direct edges 106 between all detection nodes within that group, with the edge weights 81 reflecting their relationship (e.g., frequency, similarity). For example, if Detection-1, Detection-2, and Detection-3 all occur in the same batch 110, the edges 106 may be drawn directly between them with the edge weights 81 proportional to their similarity and frequency. This could help minimize number of additional nodes (which means simpler and more interpretable graph structure).

The edge weights 81 may be calculated to suit the use. The edge weights 81, for examples, may be determined using frequency. Assume, for example, three (3) devices (Device-A, Device-B, Device-C) and two (2) processes (Process-X, Process-Y). The processes have been detected on these devices with the following frequencies over the last 30 days:
Process-X on Device-A: 20 times;
Process-X on Device-B: 15 times;
Process-X on Device-C: 25 times;
Process-Y on Device-A: 10 times;
Process-Y on Device-B: 5 times; and
Process-Y on Device-C: 30 times.
   The cybersecurity service 30 may normalize the frequency counts so that they can be used as the edge weights 81. Assume, for example, that the cybersecurity service 30 normalizes the counts by the maximum frequency observed (30 in this case):
Weight for Device-A and Process-X=20/30=0.67;
Weight for Device-B and Process-X=15/30=0.50;
Weight for Device-C and Process-X=25/30=0.83;
Weight for Device-A and Process-Y=10/30=0.33;
Weight for Device-B and Process-Y=5/30=0.17; and
Weight for Device-C and Process-Y=30/30=1.00.
   These edge weights 81 may thus indicate the strength of the relationship between each device and process. For instance, Device-C and Process-Y have the highest edge weight (1.00), suggesting a strong relationship, likely due to the high frequency of detection.

Another example of frequency-based edge weights 81 is provided. Suppose there are three (3) detections 34 (Detection-1, Detection-2, Detection-3) occurring across 4 devices (Device-E, Device-F, Device-G, Device-H) within the same time frame:
Detection-1 is seen on Device-E and Device-F,
   Detection-2 is seen on Device-G, and
Detection-3 is seen on Device-H and Device-E.

The cybersecurity service 30 may group the detections 34 into the batches 110 based on their occurrence within the same time frame. For Batch 1 {Detection-1, Detection-2, Detection-3}, the cybersecurity service 30 may calculate the frequency of each detection 34 in the batch 110:
Frequency of Detection-1 in Batch 1=2 (seen on 2 devices);
Frequency of Detection-1 in Batch 1=2 (seen on 2 devices);
Frequency of Detection-2 in Batch 1=1 (seen on 1 device);
Frequency of Detection-2 in Batch 1=1 (seen on 1 device);
Frequency of Detection-3 in Batch 1=2 (seen on 2 devices); and
Frequency of Detection-3 in Batch 1=2 (seen on 2 devices).
   The cybersecurity service 30 may calculate the edge weights 81 based on these frequencies, normalized by the total number of devices in the batch 110:
Edge Weight for Device-E and Detection-1=2/4=0.5
Edge Weight for Device-F and Detection-1=2/4=0.25
Edge Weight for Device-G and Detection-2=1/4=0.25
Edge Weight for Device-H and Detection-3=2/4=0.5

These edge weights 81 indicate the strength of the relationship between devices 36 and detections 34 within this batch 110, with higher weights 81 for more frequent occurrences.

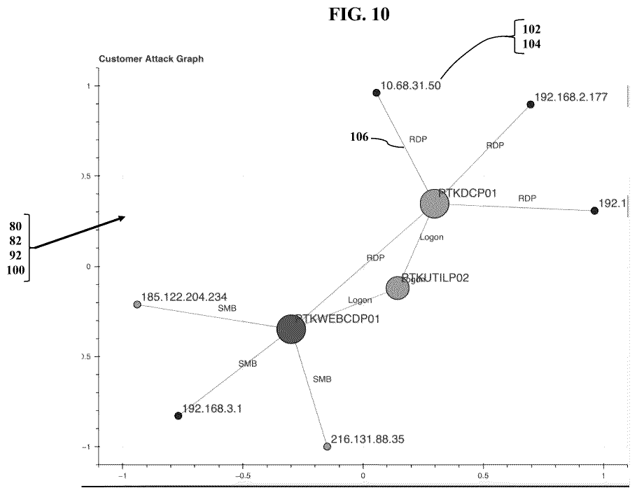

FIG. 10 visually represents the graphical data 92 as a two-dimensional attack graph 100. While the attack graph 100 may plot many different input data sets, FIG. 10 illustrates the attack graph 100 plotting IP addresses 102 as nodes 104. Each IP address 102 may be assigned to, or associated with, its corresponding host client device 36 (illustrated in FIG. 1). Each edge 106 connects at least two (2) nodes 104, and each edge 106 also describes (or is associated with) a relationship or association between the corresponding two (2) nodes 104 (such as server message block or SMB, remote desktop protocol or RDP, or logon). Because the attack graph 100 may be comprehensively built using the multi-modal input data 80 (such as devices, processes, users, and IP addresses), the attack graph 100 may have different layers of data. The attack graph 100 may thus have multiple layers, with each layer associated with a different source and/or a different entity.

The attack graph 100 reveals relationships between the nodes 104. For a given multi-modal input data 80 (such as the cybersecurity detection 34) and its associated entity (such as the device of detection or username associated with an identity detection), the server 26/60 may identify all possibly related entities (as graph nodes 104) and leverage data from the various input sources (such as network events, network traffic, cloud activity logs, identity protection events, endpoint behavioral data) associated with each device for the time frame corresponding to the cybersecurity detection 34. Nodes 104 are added based on both historical and current detection data as well as entities with no detection data to provide a comprehensive view of the incident. Edges 106 between nodes 104 are created based on interactions and relationships derived from both current and historical data. The edges 106 include direct interactions (such as process communication and network connections) as well as inferred relationships based on similar detection patterns or shared false positive cybersecurity detection characteristics representing the false positive cybersecurity detections 52 (as explained with reference to FIGS. 4-8). Based on the retrieved data, the cybersecurity service 30 constructs the graphical data 92 representing the multi-layered attack graph 100 representing the entities and relationships between the entities (processes, users, network activity) within the user's/customer's environment. Graph nodes 104 may also be represented as the cybersecurity detections 34 (e.g., one detection per node)-in addition to other entities or replacing all other entities.

Nodal entities, as examples, may be determined by relevance. The cybersecurity service 30 may select the entity as one of the nodes 104 using a relevance to detection and analysis. For example, the entity or entities involved in the detections 34 (e.g., the entity that is directly involved in or associated with detections 34) may be considered as a node 104. This includes devices, processes, users, network interfaces, IP addresses, and detection events. For example, if a process (Process-A) triggers a detection 34 on a device 36 (Device-1), both the process and the device 36 may be nodes 104 in the graph.

Nodal entities, as more examples, may be determined using potential. The entities with significant relationship and interaction potential (such as entities that interact frequently or have meaningful relationships with others) may be nodes 104. This allows the graph (e.g., the graphical data 92) to capture and analyze these interactions effectively. For example, if User-B frequently logs into Device-2 and initiates Process-C, all three entities (e.g., user, device, process) should be nodes, as their interaction may influence detection outcomes.

Nodal entities, as still more examples, may be determined using impact. Entities that are critical to a security posture of a user/group/company or other environment (such as domain controllers, critical resources, key servers, or administrative users) may be nodes 104. Their actions or compromises can have widespread effects. For example, a domain controller (DC-1) should always be a node 104, as its interactions with other entities can significantly impact the overall security of a network.

Nodal entities, as yet more examples, may be determined using contextual and/or historical importance. Entities with historical significance (that is, entities that have a history of being involved in detections 34, especially false positives) should be nodes 104. This helps in understanding patterns and preventing future FPs. For example, if a particular process (Process-D) has been flagged multiple times as a false positive, that process should be a node 104, allowing the graph (e.g., the graphical data 92) to track its process behavior over time.

Nodal entities, as even more examples, may be determined using network communications data. Some entities, for example, may have repetitive IP addresses, URLs, users/usernames, routers/modems/gateways/machines/devices, WIFI/BLUETOOTH/cellular networks, and other historical networking observances. Repetitive networking observances may be nodes 104 and/or edges 106 to track network communications over time.

Nodal entities, as more examples, may be determined using process communication. Suppose, for example, two (2) processes (such as Process-A and Process-B) are running on the same client device 36 (Device-X). Process-A spawns Process-B, and Process-B later communicates with an external server over a network. The nodes 104 and edges 106 may be created as direct interactions, for example, using the nodes 104 as the involved Process-A and Process-B. The edges 106 may be justified, as Process-A directly spawned Process-B, and an edge 106 is created between them to represent this direct process communication. The edge 106 may be labeled (such as “Process Execute”). For example, the edge 106 from Process-A to Process-B may be labeled with the label “Process Execute”to indicate the parent-child relationship.

Nodal entities, as more examples, may be determined using network interactions as the edges 106. Suppose, for example, that the nodes 104 involved are Process-B and External-Server. The edge 106 is justified, as Process-B initiates communication with the External-Server, so an edge 106 is created to represent this network interaction. The edge 106 may be labeled “Network Connection.” The edge 106, from Process-B to External-Server, in other words, may be labeled “Network Connection” indicating the communication.

Nodal entities, as more examples, may be determined using shared detection patterns. Suppose, for example, there are two (2) devices (such as Device-Y and Device-Z), and both have a process (Process-C) that has been repeatedly flagged for the same type of suspicious behavior. Both detections 34 are later determined to be FPs due to the same benign process behavior. The edge 106 may be selected using inferred relationships. The nodes 104 involved, for example, may be Device-Y, Device-Z, Process-C. As both Device-Y and Device-Z experienced the same detection pattern related to Process-C, and both were later identified as false positives, edges 106 are created between these entities to capture the inferred relationship based on shared detection patterns. The edges 106 from Device-Y to Process-C and from Device-Z to Process-C may be labeled “SuspiciousBehaviorDetected”.

Nodal entities, as more examples, may be determined using false positive characteristics 72. Suppose, for example, there are two (2) devices (such as Device-Y and Device-Z). Given that both devices shared similar false positive characteristics, an edge 106 is created directly between them, indicating this shared false positive connection. The edge 106 between Device-Y and Device-Z may be labeled with the label “Shared FP Characteristic”.

Nodal entities, as more examples, may be determined using Network Connections. Suppose an internal device (Device-A) communicates with several external IP addresses (IP-1, IP-2, IP-3) over the course of 1 day. These IP addresses are involved in similar patterns of traffic that have previously been associated with benign activities, but are sometimes flagged as suspicious. The nodes 104 involved are Device-A, IP-1, IP-2, IP-3. As Device-A has established direct communication with these IP addresses, edges 106 are created to represent these network connections. Edges 106 from Device-A to IP-1, IP-2, and IP-3 are labeled with the label “NetworkConnect” indicating the communication.

Nodal entities, as more examples, may be determined using Inferred Benign Traffic Pattern Edges. The nodes 104 involved are IP-1, IP-2, IP-3. Given that these IP addresses share a benign traffic pattern that is occasionally flagged as suspicious, edges 106 are created between them to capture this inferred relationship. Edges 106 between IP-1, IP-2, and IP-3 are labeled “Benign Traffic Pattern.”

Nodal entities, as more examples, may be determined using High/Low Interaction Rates Between Nodes. Suppose User-P interacts with multiple devices (Device-Q, Device-R) regularly. The frequency of these interactions is usually low, but suddenly spikes for Device-Q, leading to a detection. However, this spike is identified as a FP due to a known legitimate cause (e.g., a scheduled task). For Normal Interaction Rate Edges, the Nodes Involved: User-P, Device-R. An edge 106 is created between User-P and Device-R to represent the typical, low interaction rate. The edge 106 between User-P and Device-R is labeled with “UserLogon”. For the High Interaction Rate Edge, the Nodes Involved: User-P, Device-Q. An edge 106 is created between User-P and Device-Q to represent the sudden spike in interactions, which initially led to a detection 34. The Edge 106 between User-P and Device-Q is labeled with “SuspiciousUserLogon”.

Nodal entities, as stil more examples, may be determined using the false positive characteristics. Suppose the nodes 104 involved are Device-Q, User-P. As the spike was determined to be a false positive due to a legitimate scheduled task, an additional edge 106 is created to represent this FP. The edge 106 between Device-Q and User-P is labeled with “ServiceAccountLogon”.

The graphical data 92 (such as the attack graph 100) may have multiple layers of nodal relationships. Because the cybersecurity service 30, and/or the cybersecurity breach prediction service 62, may incorporate the multi-modal input data 80 from multiple different sources (such as network events, network traffic, cloud service logs, identity protection events, endpoint computer activities/behaviors/contexts), the attack graph 100 may thus have multiple different layers. Each layer may represent, or be associated with, a different source and/or a different entity. The graphical data 92 may simultaneously incorporate the source data, and thus the multiple different layers, as a single, overall graphical dataset. Indeed, each source data, and thus its corresponding layer, may be individually added or removed from the graphical data 92. Entitative relationships, as revealed by each source data and its corresponding layer, may be individually added or removed from the graphical data 92. When the server 26/60, for example (or some other computing member 28), generates the attack graph 100 for user visualization, the attack graph 100 may simultaneously display or plot each source data and its corresponding layer. A user may input commands or selections (perhaps via a user interface) that add/remove individual source layers from the attack graph 100. The user may peel back each visual layer to reveal the corresponding entitative relationship. The attack graph 100 may thus be generated and visually presented as a 2D or 3D plot having multiple layers of nodal relationships.

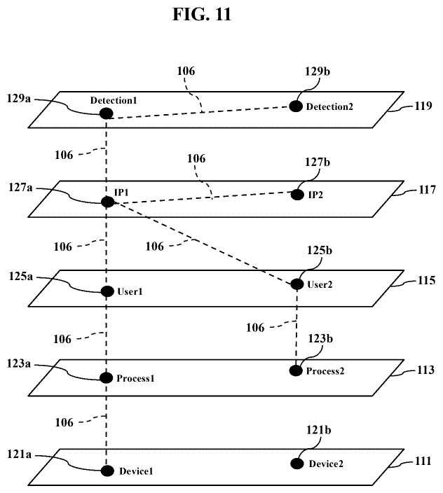

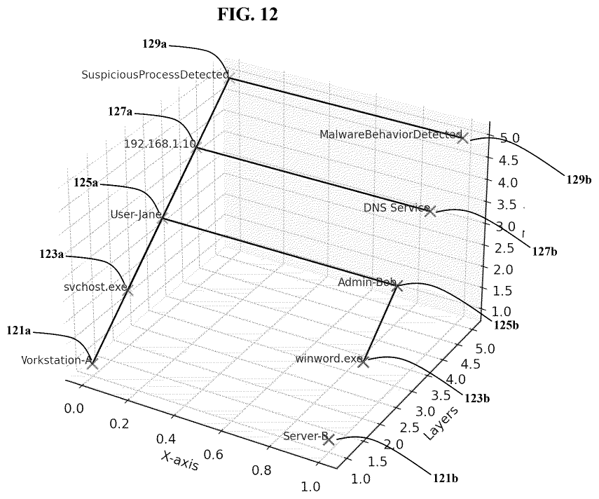

FIGS. 11-13 illustrate more examples of the graphical data 92. FIGS. 11-13 visually represents the graphical data 92 as three-dimensional attack graphs 100. FIGS. 11-12, though, only illustrate very simple three-dimensional examples of the attack graph 100. In actual, real world use, the three-dimensional attack graph 100 is far more complicated, as many nodes 104 and edges 106 are not visible. The cybersecurity service 30 and the machine learning model 88 easily learn from the complex three-dimensional attack graph 100 to identify false positives and breaches.

Returning to the simplified FIGS. 11-12, the three-dimensional attack graph 100 is simply illustrated. FIG. 11 illustrates five (5) entitative layers (such as a device layer 111, a process execution layer 113, an identity layer 115, a network layer 117, and a detection layer 119. Moreover, each layer 111-119 has two (2) corresponding intra-layer nodes (e.g., 121a-b, 123a-b, etc.). FIG. 12 illustrates a PYTHON generation of the same three-dimensional attack graph 100. The reader should note, though, that a computer system 22 (such as the rack server 60 illustrated in FIG. 9) need not represent the layered components. FIG. 12 thus omits the entitative layers 111-119 illustrated in FIG. 11. The edges 106 connected multiple nodes 121-129 having the entitative relationships (as above explained).

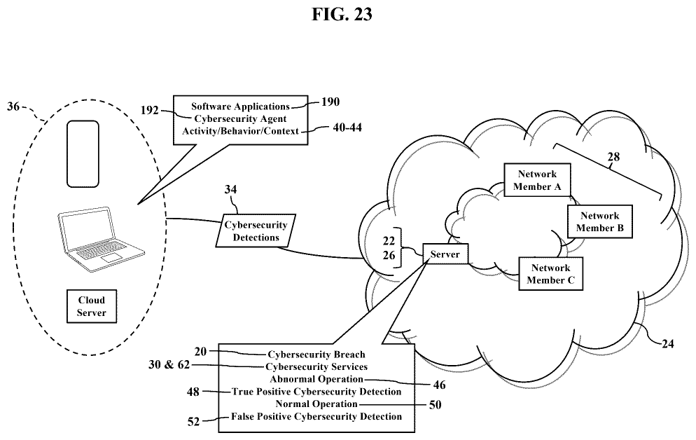

The cybersecurity service 30 thus reveals source/layer/node/edge/entity relationship(s). Let's assume an EDR (or XDR or NG SIEM) product (such as the endpoint cybersecurity sensory agent 192, as explained with reference to FIGS. 23-26) flags a suspicious process running on the client device 36. The cybersecurity service 30 determines whether this detection 34 is a false positive (FP). The cybersecurity service 30 generates the three-dimensional attack graph 100, perhaps having a few or many layers, with each layer representing different types of entities and their relationships. Suppose, for example, that layer #1 represents a Device/Host Layer with Nodes/Entities representing devices or hosts within the network (e.g., Workstation-A, Server-B). This layer represents the physical or virtual devices within the network. The edge 106 connections between devices might represent network communication, shared resources, or hierarchical relationships (e.g., parent-child relationships between virtual machines and their hypervisor). Layer 2 may be a Process/Execution Layer with Nodes/Entities representing individual processes running on devices (e.g., svchost.exe, winword.exe, etc). This layer tracks the processes behaviors and execution flow. The edges 106 represent parent-child relationships between processes, process trees (e.g., one process spawning/executing another), or even network connections initiated by processes.

More layers may be generated. Layer 3, for example, may be an Identity/User Layer with Nodes/Entities representing user identities or accounts (e.g., User-Jane, Admin-Bob). This layer focuses on user activity, identity management, and authentication events. The edge 106 connections represent user logins, session initiation, role assignments, or actions taken by users on specific devices or within specific processes. Layer 4, for example, may be a Network/Communication Layer with Nodes/Entities representing IP addresses, network interfaces, and network services (e.g., 192.168.1.10, DNS Service, etc.). This layer captures network traffic and communication patterns. The edges 106 represent communication flows, such as a process on one device communicating with another device over a specific port. Layer 5, for example, may be a Detection/Alert Layer having Nodes/Entities representing security alerts or detections 34 (e.g., SuspiciousOrAnomalousProcessTreeDetected, AbusingLegitimateApplicationLOLBinsDetected, RansomwareBehaviorDetected, RemoteAdminToolDetected, LateralMovementDetected, etc). This layer focuses on the security events flagged by various tools (e.g., EDR, XDR, NG SIEM, etc). The edge 106 connections may represent correlations between detections, such as one detection leading to or influencing another, or the same detection appearing across multiple devices or processes.

The cybersecurity service 30 reveals relationship(s) and edges across layers. Cross-Layer Relationships, for example, may flag a process (svchost.exe) in the Process/Execution Layer linked to a specific device (Workstation-A) in the Device/Host Layer. This same process might be associated with a user (User-Jane) who initiated it in the Identity/User Layer. The process could also be observed making a suspicious network connection (192.168.1.10) in the Network/Communication Layer. Finally, this behavior may trigger a detection (SuspiciousOrAnomalousProcessTreeDetected) in the Detection/Alert Layer. Edges Across Layers, as more examples, may be discovered. The edge 106 between svchost.exe in the Process Layer and Workstation-A in the Device Layer represents the process running on that device. The edge 106 between svchost.exe and User-Jane in the Identity Layer may represent the user who started the process. An edge 106 from svchost.exe to 192.168.1.10 in the Network Layer would represent the network activity initiated by the process. An edge 106 connecting svchost.exe to SuspiciousOrAnomalousProcessTreeDetected in the Detection Layer represents the detection event generated by the process's behavior.

The cybersecurity service 30 reveals Intra-Layer Relationships. Within the Process/Execution Layer, for example, edges 106 might exist between svchost.exe and winword.exe if one process spawns the other or if there's inter-process communication, or if svchost.exe injects malicious code into winword.exe. Within the Device/Host Layer, as another example, devices might be connected if they share network resources, are part of the same subnet, or have a direct communication link or there is a Lateral Movement between devices (e.g. user RDP'ing from device1 to device2). Within the Identity/User Layer, edges 106 could represent interactions between users, such as one user granting permissions to another, or role hierarchies or regular user elevates privileges, or admin user spawns app under service account to hide what they were doing.

Edges 106 may exist across or within layers. Cross-Layer Edges, for example, provide the necessary context for understanding the relationship between entities that might appear unrelated in isolation. For example, knowing that a suspicious process is running on a device often used by an admin user could provide critical context in assessing the risk or legitimacy of the detection. These edges 106 help trace the flow of events across different dimensions (e.g., from user action to process execution to network activity), which is essential for accurate threat detection and reducing false positives. Intra-Layer Edges, as more examples, reveal relationships within the same category, such as multiple processes on the same device or user interactions within a particular system. Understanding these relationships helps in identifying patterns of behavior that could either confirm or contradict the suspicion of malicious activity. For example, multiple processes communicating in a known benign pattern might reduce the likelihood of an FP, whereas an unusual communication pattern might raise an alert.

As FIGS. 11-13 show, the graphical data 92 (such as the attack graph 100) may have multiple layers of nodal relationships. Because the false positive prediction service 52 may incorporate data from multiple different sources (such as network events, network traffic, cloud service logs, identity protection events, the endpoint computer activities/behaviors/contexts 40-44, and other false positive cybersecurity detection characteristics), the attack graph 100 may thus multiple different layers. This layered approach allows the cybersecurity service 40 to create a highly context-rich model of the incident in customer environment that can then be utilized (such as by the machine learning model 88) to find FPs (or even detect new patterns indicative of a breach).

The cybersecurity breach prediction service 62 may perform the cross-layer correlation analysis 84 (illustrated in FIG. 1). Because the cybersecurity service 30, and/or the cybersecurity breach prediction service 62, generates the multi-layered graph 82 having multiple layers, the cybersecurity breach prediction service 62 may conduct one or more cross-layer correlation analyses 84. The cybersecurity breach prediction service 62 may stack/overlay and/or peel away layers from the multi-layered graph 82, thereby discovering correlations for events from different domains. The cybersecurity breach prediction service 62 may build relationships between graphical nodes across different layers and identify potential pathways for attacker movement. Relationships within layers, for example, may reveal intralayer relationships between entities (such as all processes executed by the same user). Relationships between layers, as more examples, may reveal interlayer relationships between entities across layers. For instance, a process execution event on a device (such as Layer 1) connects to the user who initiated the process (such as Layer 2). As another example, a compromised user account or remote IP address (such as Layer 1) may be linked to suspicious cloud activity (Layer 2) involving unauthorized access attempts.

The cybersecurity services 30 and/or 62 may use batch statistical analysis of detection frequency. The cybersecurity services 30 and/or 62 may group the cybersecurity detections 34 into logical batches (such as entitative batches associated with an entity). Batch analysis helps identify commonalities and focuses on analyzing detection frequencies within batches of data, where a batch corresponds to a defined group of the cybersecurity detections 34, depending on detection context (such as user specific detection from IDP and/or EDR detections of processes on a managed devices) processed during a specified time interval. The cybersecurity services 30 and/or 62 may group the cybersecurity detections 34 that are logically related, either by the type of detection, entities involved, or other shared characteristics. Each group or batch may include a set of related entities, such as devices, users, and/or processes. The cybersecurity services 30 and/or 62 may analyze the frequency of all cybersecurity detections 34 occurring within a batch over a specified time interval. Statistical analysis is then performed to identify the cybersecurity detections 34 that frequently occur within the batch. The cybersecurity services 30 and/or 62 thus identify statistical insights for common or recurring detections. Each batch, defined by a group of similar entities (e.g., devices, users, processes) helps in structuring the attack graph 100. These entities and their interactions (e.g., the edges 106 illustrated in FIG. 9) are embedded in the attack graph 100 based on the commonalities identified in the batch analysis (shared attributes, similar types, etc.).

The graphical data 92 may incorporate statistical edge weighting. The graphical data 92 (illustrated as the attack graph 100) has the nodes 104 and the interconnecting edges 106. The edges 106 may be weighted with the edge weights representing the false positive cybersecurity detection characteristics 162 associated with the entity/entities. The false positive prediction service 52 may assign the edge weights based on the statistical analysis of detection frequency (based on the analysis from batched detections, such as the entitative batches 110). The edge weights may thus reflect the significance or strength of relationships. Higher values for the edge weights are assigned to connections, indicating stronger or more relevant connections for the analysis of false positives (such as the cybersecurity detections 34 that frequently occur on multiple devices or occurring in patterns). The edge weights, as examples, may provide statistical context for graph neural networks (or GNNs). The cybersecurity services 30/62 may thus identify the high-probability false positive cybersecurity detections 52 within the batch (such as the entitative batch) by using the statistical weighting of the graphical edges 106 and the analysis by GNNs. Overall this task helps prioritize the examination of relationships that are more likely to contribute to false positives. The edge weights are assigned not just based on the occurrence/count of the cybersecurity detections 34, but also taking into account the timing of the cybersecurity detections 34 (for example, more recent cybersecurity detections 34 could be given higher weights). The cybersecurity detections 34 may be aggregated based on similarity or type before assigning weights. Multiple cybersecurity detections 34 may have different weights and create different edges 106 between nodes 104. Even if the edge 106 itself is not directly related to the detection entity, the interaction between nodes 104 might still provide valuable context that influences the likelihood of false positives.

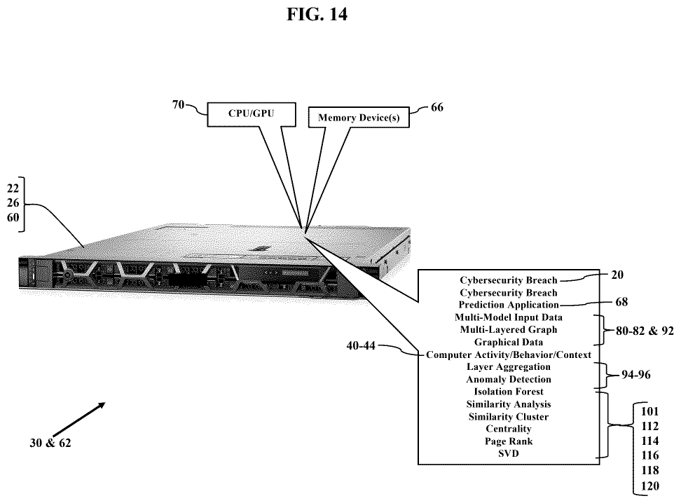

FIG. 14 illustrates examples of the layer aggregation 94 and anomaly detection 96. The graphical data 92 (such as the attack graph 100 illustrated by FIGS. 9-13) may be a very large dataset object. In a typical enterprise network, for example, the cybersecurity service 30 may receive hundreds or even thousands of separate entities (such as users and/or the client devices 36, as illustrated in FIG. 1) establishing network connections to each other. Moreover, each of these entities may be actively running many software/OS processes and generating thousands of telemetry events describing these behaviors. The cybersecurity service 30 could, of course, enumerate every relevant entity and all relevant behavior/actions of those entities. All these entitative behaviors, however, could produce a huge byte-sized, unwieldy, and uninformative data object (such as the graphical data 92 representing the attack graph 100).

The cybersecurity services 30/62, however, may implement elegant data reduction techniques. The cybersecurity breach prediction service 62, for example, accepts the large byte-sized graphical data 92 (such as the attack graph 100 of entities and their associated behaviors) and identifies data elements that may be pruned or thrown out because they are not relevant or interesting. The cybersecurity breach prediction service 62, for example, may identify specific telemetry events that can be dropped and/or identify entire entities that can be scrubbed from the graphical data 92 (so all of their corresponding computer activity/behavior/context 40/42/44 may also be dropped).

The cybersecurity breach prediction service 62 may effectively implement anomaly detection techniques. The cybersecurity breach prediction service 62, for example, may specifically prune or exclude computer activity/behavior/context 40/42/44 that is redundant or inaccurate. The cybersecurity breach prediction service 62, for example, may identify computer activity/behavior/context 40/42/44 and other events that are anomalous relative to other observations. The cybersecurity breach prediction service 62 may then select the more anomalous activity/behavior/context 40/42/44 and other events for inclusion or exclusion (for example, relying on the assumption that important steps in a cybersecurity incident will often not consist of super common behaviors). The cybersecurity breach prediction service 62, as an example, may utilize an isolation forest algorithm 101 to identify outlier anomalies in the multi-modal input data 80 and/or the computer activity/behavior/context 40/42/44. The cybersecurity services 30/62 may thus identify anomalous computer activity/behavior/context 40/42/44 that best describes the cybersecurity breach 20. The cybersecurity breach prediction service 62 may also prune or exclude some, most, or all of the normal or common computer activity/behavior/context 40/42/44 as not indicative of the cybersecurity breach 20.

The cybersecurity breach prediction service 62 may utilize cluster analysis. The cybersecurity services 30/62 may apply a similarity analysis 112 to the multi-modal input data 80 and/or to the computer activity/behavior/context 40/42/44. The cybersecurity services 30/62 may then group the multi-modal input data 80 and/or the computer activity/behavior/context 40/42/44 into similarity clusters 114, based on the similarity analysis 112. The cybersecurity services 30/62, for example, may group similar events together and also deduplicate similar results. As a common example, the cybersecurity service 30 may receive hundreds of nearly identical behavioral events. These hundreds of nearly identical behavioral events can greatly increase the byte size of the graphical data 92 and strain processor, memory, and network resources. Because the hundreds of behavioral events are nearly identical, the hundreds of behavioral events may have great/much similarity measures. The cybersecurity services 30/62 may thus replace the hundreds of nearly identical behavioral events with a single, representative computer activity/behavior/context 40/42/44. By clustering events, the cybersecurity breach prediction service 62 may identify these highly similar computer activity/behavior/context 40/42/44 and drop all but a single representative event to capture the same behavior.

The cybersecurity breach prediction service 62 may also prune entities. Indeed, by pruning the entities, the cybersecurity breach prediction service 62 may additionally and implicitly prune IP/network connections between the entities. The cybersecurity breach prediction service 62, as an example, may leverage graph-based approaches. The cybersecurity breach prediction service 62 may determine or measure centrality 116 (such as associated with the entity) to the graphical data 92 and/or the multi-layered graph 82. Central entities, for example, may be more likely important indicators of the cybersecurity breach 20. The cybersecurity breach prediction service 62, as another example, may determine or measure the centrality 116 using a page rank algorithm 118 or other weighting scheme. The cybersecurity breach prediction service 62, as more examples, may identify typical or common connection patterns between entities via singular value decomposition (or SVD) 120 using a matrix. The cybersecurity breach prediction service 62 may implement the SVD 120, and/or SVD-like techniques, to estimate a typical connection pattern of an entity, based on data from similar entities and flagged unusual connections. The cybersecurity breach prediction service 62 is thus perhaps more likely to include an unusual/outlier/anomalous connection in the graphical data 92 and/or the multi-layered graph 82, as unusual/outlier/anomalous data is more likely to be associated with a possible incident and the cybersecurity breach 20.

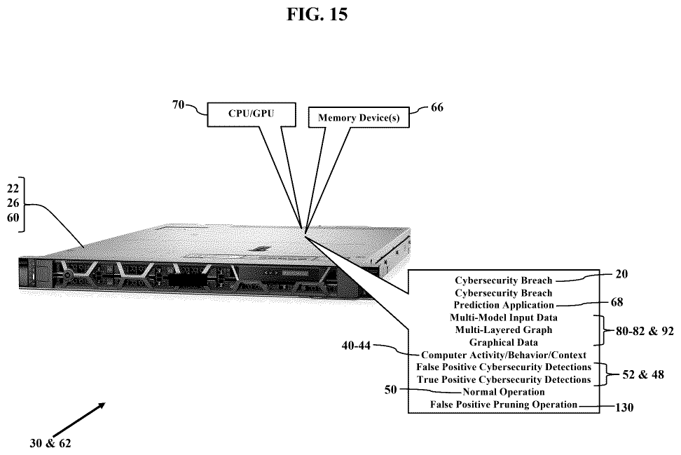

FIGS. 15-18 illustrate examples of false positive pruning. The server 26 (again illustrated as the rack server 60) retrieves the multi-modal input data 80 via a communications network (such as the cloud computing environment 24 or other communications network, as FIG. 1 illustrated). The cybersecurity breach prediction application 68, for example, may cause or instruct the server 26/60 to generate the graphical data 92 (perhaps representing the multi-layered graph 82) using the multi-modal input data 80 sourced from the multiple sources (as explained with reference to FIGS. 4-8). Because the multi-modal input data 80 may be voluminous, the graphical data 92 may be a very large dataset object representing hundreds or even thousands of separate entities, operating system processes, and network connections. The graphical data 92, describing all these entitative computer activities/behaviors/contexts 40/42/44, may produce a huge byte-sized, unwieldy, and uninformative data object (such as the attack graph 100 having numerous nodes 104 and edges 106, as illustrated in FIGS. 10-13).

The cybersecurity breach prediction service 62, however, may prune false positives. The graphical data 92 describes many computer activities/behaviors/contexts 40/42/44. Some of these computer activities/behaviors/contexts 40/42/44, though, may represent or describe the false positive cybersecurity detections 52. That is, the graphical data 92 may include a mixture of nodes 104 and/or edges 106 (illustrated in FIGS. 10-13) representing both the true positive cybersecurity detections 48 and the false positive cybersecurity detections 52. The cybersecurity breach prediction service 62 may thus implement an elegant false positive pruning operation 130 that reduces or compresses the graphical data 92. The false positive pruning operation 130 prunes, culls, and/or drops the computer activities/behaviors/contexts 40/42/44 that represent or describe the false positive cybersecurity detections 52. Because the false positive cybersecurity detections 52 are actually the normal operation 50, the false positive cybersecurity detections 52 may be irrelevant to determining or to predicting the cybersecurity breaches 20. The cybersecurity breach prediction service 62 may thus delete or scrub nodes 104 and/or edges 106 (e.g., activities/behaviors/contexts 40/42/44) representing the false positive cybersecurity detections 52 from the graphical data 92.

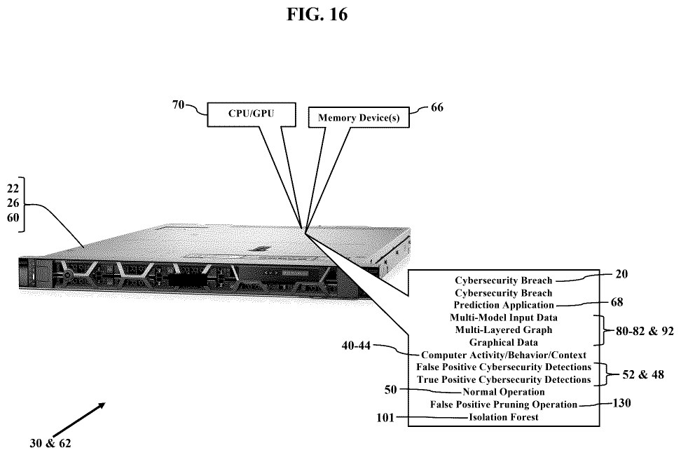

FIG. 16 illustrates true positive isolation. The cybersecurity breach prediction service 62 may identify and prune false positives. The cybersecurity breach prediction service 62, for example, may identify the graphical data 92 (such as the nodes 104 and/or edges 106 illustrated in FIGS. 9-13) that represent or describe the normal operation 50. The normal operation 50, however, also includes the computer activities/behaviors/contexts 40/42/44 representing the false positive cybersecurity detections 52. The cybersecurity breach prediction service 62 may then execute the false positive pruning operation 130 utilizing the isolation forest algorithm 101 to identify the true positive cybersecurity detections 48 as outlier anomalies. That is, the isolation forest algorithm 101 may segregate or partition the normal operation 50 (including the computer activities/behaviors/contexts 40/42/44 representing the false positive cybersecurity detections 52) from the true positive cybersecurity detections 48. The false positive cybersecurity detections 52 are thus isolated from the true positive cybersecurity detections 48. The cybersecurity breach prediction service 62 may thus drop or prune the false positive cybersecurity detections 52 (e.g., their corresponding computer activities/behaviors/contexts 40/42/44) from the graphical data 92, as these normal operations 50 are unlikely to contribute to cybersecurity breach detection. Once the false positive cybersecurity detections 52 are pruned, the remaining graphical data 92 may only describe the computer activities/behaviors/contexts 40/42/44 representing the true positive cybersecurity detections 48. The false positive pruning operation 130 thus results in the graphical data 92 that best describes the cybersecurity breaches 20.

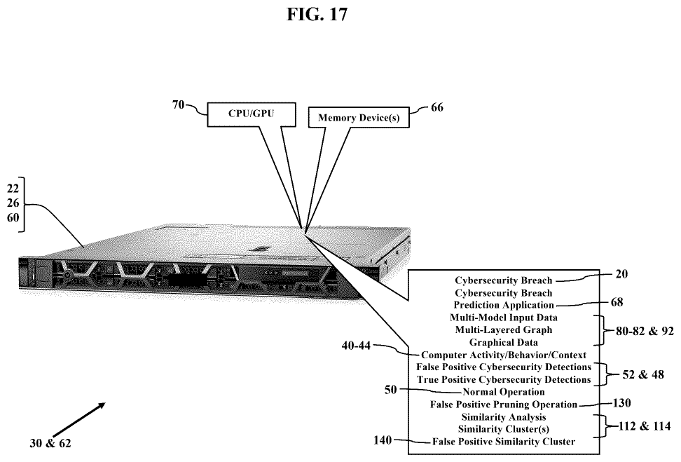

FIG. 17 illustrates false positive clustering. The cybersecurity breach prediction service 62 may again identify and prune the false positive cybersecurity detections 52. The cybersecurity breach prediction service 62, for example, may execute the false positive pruning operation 130 by applying the similarity analysis 112 to the graphical data 92. The cybersecurity breach prediction service 62 may then group the graphical data 92 (such as the events representing the multi-modal input data 80 and/or the computer activity/behavior/context 40/42/44) into the similarity cluster(s) 114, based on the similarity analysis 112. One or more of the similarity clusters 114, though, may represent the false positive cybersecurity detections 52. Again, the false positive cybersecurity detections 52 represent the multi-modal input data 80, and/or the computer activities/behaviors/contexts 40/42/44, that are determined to be the normal operation 50. The graphical data 92 may thus include one or more false positive similarity clusters 140 that represent nodal groupings of similar false positive cybersecurity detections 52. Because the false positive similarity clusters 140 represent the normal operation 50, the false positive similarity clusters 140 are unlikely to contribute to abnormal, cybersecurity breach detection. The cybersecurity breach prediction service 62 may thus implement the false positive pruning operation 130 that reduces or compresses the graphical data 92. The cybersecurity breach prediction service 62 may prune, delete, or remove the nodal false positive similarity clusters 140 (e.g., their corresponding computer activities/behaviors/contexts 40/42/44) from the graphical data 92. Once the false positive cybersecurity detections 52 are pruned, the remaining graphical data 92 may only describe the computer activities/behaviors/contexts 40/42/44 representing the true positive cybersecurity detections 48. The false positive pruning operation 130 thus results in the graphical data 92 that best describes the cybersecurity breaches 20.

The false positive pruning operation 130 improves computer functioning. The cybersecurity service 30 may receive trillions of events (such as the computer activities/behaviors/contexts 40/42/44) per day. These huge quantities of events, and their relationships, can create huge byte sized graphical data 92 that strains processor, memory, and network resources. Moreover, as some or many of these events may describe normal operation 50, the strained computer/network resources are wasted slugging through the false positive cybersecurity detections 52. The cybersecurity breach prediction service 62 may thus perform the false positive pruning operation 130 that prunes or culls the nodes 104 and/or edges 106 (illustrated in FIGS. 9-13) representing false positive cybersecurity detections 52 from the graphical data 92. By dropping the false positive similarity clusters 140 (and their corresponding nodes 104 and/or edges 106), for example, the cybersecurity breach prediction service 62 reduces the graphical data 92 to mostly, or to only, the true positive cybersecurity detections 48. The graphical data 92 mostly, or solely, represents and/or contains the true positive cybersecurity detections 48 representing abnormal computer activities/behaviors/contexts 40/42/44.

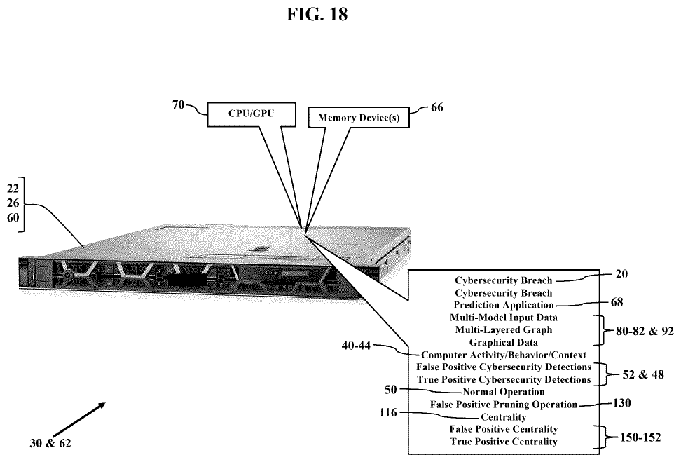

FIG. 18 illustrates more false positive pruning schemes. The false positive pruning operation 130 may utilize additional or alternative schemes. The cybersecurity breach prediction service 62 may execute the false positive pruning operation 130 by determining or measuring the centrality 116 to the graphical data 92 and/or to the multi-layered graph 82. A false positive centrality 150, for example, may indicate the nodes 104 and/or edges 106 (illustrated in FIGS. 9-13) representing normal operation 50 and the false positive cybersecurity detections 52. A true positive centrality 152, as another example, may indicate other nodes 104 and/or edges 106 representing abnormal operation 50 and the true positive cybersecurity detections 48. The entities and/or events associated with the true positive centrality 152 may be more likely important indicators of the cybersecurity breach 20. The entities and/or events associated with the false positive centrality 150, though, are likely unimportant indicators of the cybersecurity breach 20. The cybersecurity breach prediction service 62 may thus perform the false positive pruning operation 130 that prunes or culls the false positive nodes 104 and/or edges 106, that correspond to the false positive centrality 150, from the graphical data 92. By dropping the false positive centrality 150 (and their corresponding computer activities/behaviors/contexts 40/42/44), the cybersecurity breach prediction service 62 reduces the graphical data 92 to mostly, or to only, the nodes 104 and/or edges 106 representing the true positive cybersecurity detections 48. The graphical data 92 mostly, or solely, represents and/or contains the true positive cybersecurity detections 48 representing abnormal computer activities/behaviors/contexts 40/42/44.

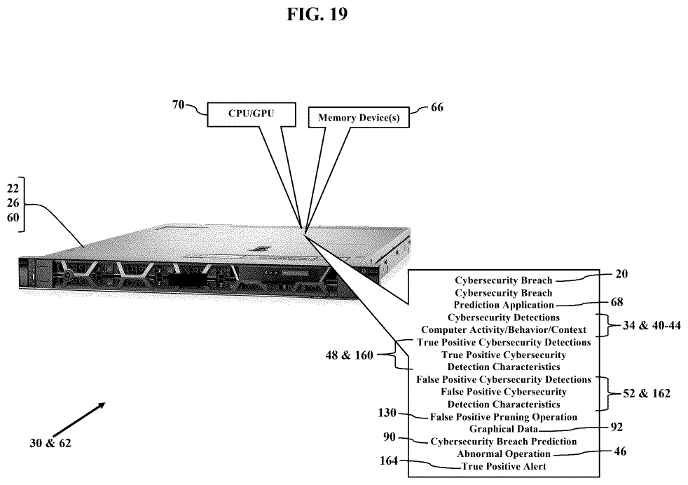

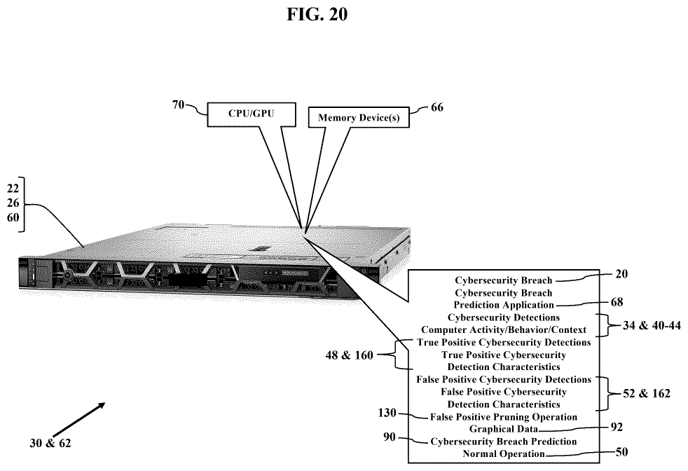

FIGS. 19-20 illustrate examples of profile breach detection. The digital cybersecurity breach prediction service 62 may receive hundreds, thousands, or even millions of weekly cybersecurity detections 34. These cybersecurity detections 34 may describe trillions of sequential/serial events representing the computer activities/behaviors/contexts 40/42/44. The digital cybersecurity service 30 may store and analyze these events to accurately identify the true positive cybersecurity detections 48. The digital cybersecurity service 30, however, may also accurately identify the false positive cybersecurity detections 52. The cybersecurity breach prediction application 68, for example, may instruct or cause the server 26 (again illustrated as the rack server 60) to determine the true positive cybersecurity detection characteristics 160 having pruned therefrom the false positive cybersecurity detection characteristics 162. The cybersecurity breach prediction application 68 may analyze historical records to determine the true positive cybersecurity detection characteristics 160 that are representative of the true positive cybersecurity detections 48. The cybersecurity breach prediction application 68 may also analyze historical records to determine the false positive cybersecurity detection characteristics 162 that are representative of the false positive cybersecurity detections 52. The cybersecurity breach prediction application 68 may then apply the false positive pruning operation 130 (as explained with reference to FIGS. 15-18) to identify and to prune/drop/cull the false positive cybersecurity detection characteristics 162 from the true positive cybersecurity detection characteristics 160. By dropping the false positive cybersecurity detection characteristics 162 (and their corresponding computer activities/behaviors/contexts 40/42/44), the cybersecurity breach prediction service 62 reduces the graphical data 92 to mostly, or to only, the true positive cybersecurity detection characteristics 160 representative of the true positive cybersecurity detections 48. The graphical data 92 mostly, or solely, represents and/or contains the true positive cybersecurity detections 48 representing abnormal computer activities/behaviors/contexts 40/42/44.

The cybersecurity breach prediction 90 is much more accurate. When the digital cybersecurity service 30 then receives a current cybersecurity detection 34, the cybersecurity service 30 may forward the cybersecurity detection 34 to the cybersecurity breach prediction service 62 (such as the server 26/60) for fast analysis. The cybersecurity breach prediction application 68 instructs or causes the server 26/60 to compare the cybersecurity detection 34 to the true positive cybersecurity detection characteristics 160 having pruned therefrom the false positive cybersecurity detection characteristics 162. The cybersecurity breach prediction application 68 instructs or causes the server 26/60 to generate the cybersecurity breach prediction 90 associated with the cybersecurity detection 34, based on the comparison of the cybersecurity detection 34 to the true positive cybersecurity detection characteristics 160 having pruned therefrom the false positive cybersecurity detection characteristics 162. As an example, if the cybersecurity detection 34 equals, matches, satisfies, lies within, or conforms to the graphical data 92 representing the true positive cybersecurity detection characteristics 160, then the cybersecurity breach prediction application 68 may determine that the cybersecurity detection 34 is the true positive cybersecurity detection 48. The cybersecurity detection 34, and its associated computer activities/behaviors/contexts 40/42/44, have been historically observed, concurrently observed, graphed/plotted, and/or assessed as the abnormal operation 46. Because the cybersecurity detection 34 conforms to, shares, or exhibits the true positive cybersecurity detection characteristics 160, the cybersecurity breach prediction application 68 may further label or categorize the cybersecurity detection 34 as the abnormal operation 50. Moreover, because the cybersecurity detection 34 equals, satisfies, or lies within the true positive cybersecurity detection characteristics 160, the cybersecurity breach prediction application 68 may label, categorize, or predict the cybersecurity detection 34 as another true positive cybersecurity detection 48. The cybersecurity breach prediction application 68 may further authorize and/or escalate a deeper analysis or review of the cybersecurity detection 34, such as by instructing the server 26/60 to generate a true positive alert or other notification 164 indicating the cybersecurity detection 34 represents the true positive cybersecurity detection 48 and/or the abnormal operation 46. The true positive alert 164 may be sent to any network address (e.g., IP address) associated with any supervisory or notification system associated with the cloud computing environment 24 (illustrated in FIG. 1).

FIG. 20, though, illustrates a normal prediction. When the cybersecurity detection 34 is compared to the true positive cybersecurity detection characteristics 160, the cybersecurity breach prediction application 68 may determine that the cybersecurity detection 34, and its associated computer activities/behaviors/contexts 40/42/44, represents the normal operation 50. As an example, the cybersecurity detection 34 may fail to conform to the graphical data 92 representing the true positive cybersecurity detection characteristics 160. That is, the cybersecurity detection 34 is unequal to, does not match, does not satisfy, or lies outside of the true positive cybersecurity detection characteristics 160. When the cybersecurity detection 34 does not share or represent the true positive cybersecurity detection characteristics 160, then the cybersecurity breach prediction application 68 may determine that the cybersecurity detection 34 is unlike, or does not resemble, true positives. The cybersecurity breach prediction application 68 may determine that the cybersecurity detection 34, and its associated computer activities/behaviors/contexts 40/42/44, is the false positive cybersecurity detection 52. Because the cybersecurity detection 34 does not conform to the true positive cybersecurity detection characteristics 160, the cybersecurity breach prediction application 68 may further label or categorize the cybersecurity detection 34 as the safe or normal operation 50. Moreover, cybersecurity breach prediction application 68 may further predict, label, and/or categorize the cybersecurity detection 34 as the false positive cybersecurity detection 52. The cybersecurity breach prediction application 68 may thus de-escalate, cancel, or even terminate any further inspection, analysis, or review of the cybersecurity detection 34 and its associated computer activities/behaviors/contexts 40/42/44. The server 26/60, and the cybersecurity breach prediction service 62, may thus reallocate processor, memory, and network resources to other tasks.

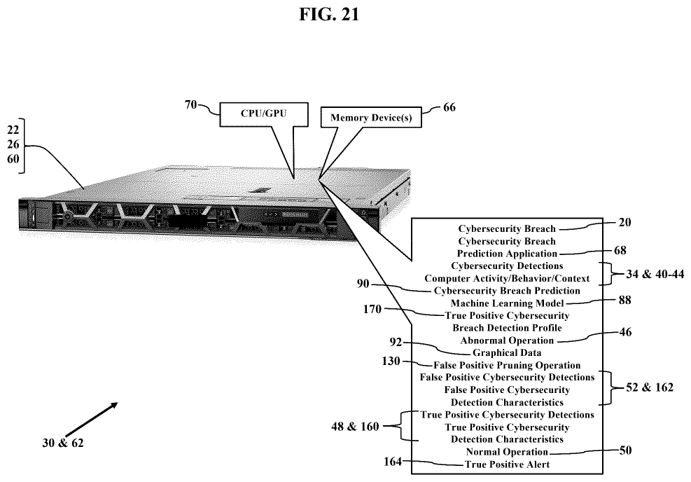

FIG. 21 illustrates examples of machine learning. The digital cybersecurity service 30 and/or the cybersecurity breach prediction service 62 (such as performed by the rack server 60) may generate the fast and effective cybersecurity breach prediction 90. When the server 26/60 receives the cybersecurity detection 34, the server 26/60 may execute the cybersecurity breach prediction application 68 as a predictor engine. The server 26/60 may ingest the cybersecurity detection 34 as an input, and the cybersecurity breach prediction application 68 instructs the server 26/60 to compare the cybersecurity detection 34 to a true positive cybersecurity breach detection profile 170 generated by the machine learning model 88. The true positive cybersecurity breach detection profile 170 may graphically, statistically, and/or numerically define or specify process events, communications, data values, patterns, contextual login/location, and/or other computer activities/behaviors/contexts 40/42/44 that have been assessed as true positive, abnormal operation 46. The true positive cybersecurity breach detection profile 170, for example, may be generated from the graphical data 92 having pruned therefrom the false positive cybersecurity detection characteristics 162 that represent the false positive cybersecurity detections 52 (such via the false positive pruning operation 130, as explained with reference to FIGS. 15-18). The true positive cybersecurity breach detection profile 170, in other words, may describe abnormal or true positive identities, locations, operating system events, and/or other suspicious/malicious computer activities/behaviors/contexts 40/42/44. The true positive cybersecurity breach detection profile 170 may thus represent historical/current information, data, bits/bytes, and/or other electronic content that is/are known to indicate the abnormal operation 46. Whatever information or data is described by, or associated with, the cybersecurity detection 34, that information or data may be compared to the true positive cybersecurity breach detection profile 170. If the electronic content represented by the cybersecurity detection 34 equals, matches, satisfies, lies within, or conforms to the true positive cybersecurity breach detection profile 170, then the cybersecurity breach prediction application 68 may determine that the cybersecurity detection 34 shares, contains, or represents the abnormal operation 46.

The true positive cybersecurity breach detection profile 170 may be generated by the machine learning model 88. The machine learning model 88 may be a network resource or service provided by the cloud computing environment 24 (illustrated in FIG. 1). The machine learning model 88 may also be resource or service provided by a contractor or third party service provider (not shown for simplicity). For simplicity, though, FIG. 21 illustrates the machine learning model 88 as a service, module, or function provided by the server 26/60. The server 26/60 may thus execute the machine learning model 88 to build the true positive cybersecurity breach detection profile 170. The machine learning model 88 may be trained using the graphical data 92 representing only the true positive cybersecurity detections 48 having pruned therefrom the false positive cybersecurity detections 52. The cybersecurity breach prediction service 62, for example, may thus perform the false positive pruning operation 130 that prunes or culls the false positive cybersecurity detections 52 from the graphical data 92. By dropping the false positive computer activities/behaviors/contexts 40/42/44, the cybersecurity breach prediction service 62 reduces the graphical data 92 to mostly, or to only, the true positive computer activities/behaviors/contexts 40/42/44 representing the true positive cybersecurity detections 48. The true positive cybersecurity breach detection profile 170 may thus statistically identify (e.g., ±3σ standard deviations) the false positive cybersecurity detections 52. Because the machine learning model 88 builds the true positive cybersecurity breach detection profile 170, the machine learning model 88 may more accurately predict a range of the abnormal operation 46, in terms of past/historical/habitual/current true positive cybersecurity detection characteristics 160.

The server 26 may thus statistically identify the abnormal operation 46. Because the machine learning model 88 builds the true positive cybersecurity breach detection profile 170, the machine learning model 88 may statistically predict a range of the abnormal operation 46. The true positive cybersecurity breach detection profile 170, in other words, may specify names, processes, and/or values that describe ranges of the abnormal operation 46, such as terms defining abnormal or unexpected process events, communications, activities, behaviors, data values, patterns, contextual login/location, or other electronic content. These terms, associated with the abnormal operation 46, may derive from computer analysis and/or human cybersecurity subject matter experts scrutinizing thousands or millions of historical and current cybersecurity detections 34. Computers and/or humans may then label or categorize the cybersecurity detections 34 as the abnormal operation 46 or the normal operation 50. As a simple example, the machine learning model 88 may generate the true positive cybersecurity breach detection profile 170 using Gaussian probability distributions based on the graphical data 92. Here, though, because the false positive cybersecurity detections 52 have been pruned from the graphical data 92 (such as via the false positive pruning operation 130), the graphical data 92 represents mostly or only the true positive computer activities/behaviors/contexts 40/42/44 representing the true positive cybersecurity detections 48. The reduced, true positive graphical data 92 may thus be used to train the machine learning model 88 to more accurately generate the cybersecurity breach prediction 90 of the cybersecurity breach 20. The true positive cybersecurity breach detection profile 170, in particular, may describe one or more standard deviations and confidence intervals representing ranges of the abnormal operation 46. As the cybersecurity breach prediction application 68 inspects the current cybersecurity detection 34, the statistical machine learning model 88 may be used to predict that the cybersecurity detection 34 lies within, or deviates or differs from, the true positive cybersecurity breach detection profile 170.

The cybersecurity breach prediction 90 may be generated. Once the cybersecurity detection 34 is compared to the true positive cybersecurity breach detection profile 170, the cybersecurity breach prediction application 68 may generate the cybersecurity breach prediction 90. As an example, if the cybersecurity detection 34 equals, matches, satisfies, lies within, or conforms to the true positive cybersecurity breach detection profile 170, then the cybersecurity breach prediction application 68 may determine that the cybersecurity detection 34 is the true positive cybersecurity detection 48. The cybersecurity detection 34, and its associated computer activities/behaviors/contexts 40/42/44, have been historically observed, concurrently observed, and/or assessed as the abnormal operation 46. Because the cybersecurity detection 34 conforms to the true positive cybersecurity breach detection profile 170, the cybersecurity breach prediction application 68 may further label or categorize the cybersecurity detection 34 as the abnormal operation 46. Moreover, because the cybersecurity detection 34 conforms to the true positive cybersecurity breach detection profile 170, the cybersecurity breach prediction application 68 may further predict, label, and/or categorize the cybersecurity detection 34 as the true positive cybersecurity detection 48. The cybersecurity breach prediction application 68 may further authorize and/or escalate a deeper analysis or review of the cybersecurity detection 34, such as by instructing the server 26/60 to generate the true positive alert or other notification 164 indicating the cybersecurity detection 34 represents the true positive cybersecurity detection 48 and/or the abnormal operation 46. The true positive alert 164 may be sent to any network address (e.g., IP address) associated with any supervisory or notification system associated with the cloud computing environment 24 (illustrated in FIG. 1).

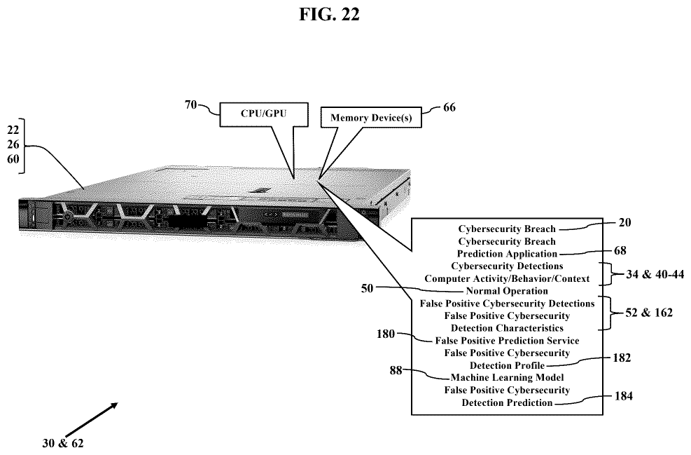

FIG. 22 illustrates examples of false positive prediction. The digital/binary cybersecurity service 30 and/or the cybersecurity breach prediction service 62 may predict whether the cybersecurity detection 34 (and its associated computer activity/behavior/context 40/42/44) are false positive, normal operation 50. That is, when the cybersecurity breach prediction application 68 analyzes the cybersecurity detection 34, the cybersecurity breach prediction application 68 may additionally or alternatively predict whether the cybersecurity detection 34 is another one of the false positive cybersecurity detections 52 representing the normal operation 50. The cybersecurity breach prediction application 68, in other words, may predict false positives, before the cloud computing environment 24 (illustrated in FIG. 1) expends significant hardware and network resources. The digital/binary cybersecurity service 30 may thus additionally or alternatively implement a false positive prediction service 180 that preliminarily screens and a priori predicts the false positive cybersecurity detections 52. When the server 26/60, for example, receives the cybersecurity detection 34, the server 26/60 may retrieve and acquire log data that further describes, explains, or surrounds the cybersecurity detection 34 (such as the computer activity/behavior/context 40/42/44). Because the server 26/60 executes the cybersecurity breach prediction application 68 as a predictor engine, the cybersecurity breach prediction application 68 may instruct or cause the server 26/50 to compare the cybersecurity detection 34 to a false positive cybersecurity detection profile 182. The false positive cybersecurity detection profile 182 contains or describes data representing the false positive cybersecurity detection characteristics 162, perhaps associated with a user, group of users, device(s), company/employer, or other entity. The false positive cybersecurity detection profile 182 describes the false positive cybersecurity detections 52. The false positive cybersecurity detection profile 182 defines, specifies, or represents predetermined or known computer activity/behavior/context 40/42/44 that have been assessed or prescribed as the safe or normal operation 50. The false positive cybersecurity detection profile 182, in other words, may describe habitual, routine, current, and/or harmless computer activity/behavior/context 40/42/44 associated with a user, group of users, employees, company, employer, or other entity. The false positive cybersecurity detection profile 182 may represent historical logs, information, actions, inputs, bits/bytes, values, averages/ranges, and/or other false positive cybersecurity detection characteristics 162 that is/are known to indicate the false positive cybersecurity detections 52.

False positives may be machine learned. The false positive cybersecurity detection profile 182, as a simple example, may be generated by the machine learning model 88. The machine learning model 88 may be trained using only the false positive cybersecurity detection characteristics 162 (as labeled or categorized by computer analysis and/or human cybersecurity experts). The false positive cybersecurity detection profile 182 may store or represent statistical ranges or values (e.g., ±3σ standard deviations) describing past or historical false positive cybersecurity detection characteristics 162 that have been previously logged and/or assessed as the normal operation 50. The false positive cybersecurity detection profile 182 thus contains or represents a rich description of the historical and current false positive cybersecurity detection characteristics 162 that reflect the false positive cybersecurity detections 52.

A false positive cybersecurity prediction 184 may be generated. Once the cybersecurity detection 34 is compared to the false positive cybersecurity detection profile 182, the cybersecurity breach prediction application 68 may generate the false positive cybersecurity prediction 184. As an example, if the computer activities/behaviors/contexts 40/42/44 associated with the cybersecurity detection 34 equal, match, satisfy, lie within, or conform to the false positive cybersecurity detection profile 182, then the cybersecurity breach prediction application 68 may determine that the cybersecurity detection 34 is the false positive cybersecurity detection 52. The cybersecurity detection 34, and its associated computer activities/behaviors/contexts 40/42/44, have been historically observed, concurrently observed, and/or assessed as the safe or normal operation 50. Because the cybersecurity detection 34 conforms to the false positive cybersecurity detection profile 182, the cybersecurity breach prediction application 68 may further label or categorize the cybersecurity detection 34 as the false positive cybersecurity detection 52. The cybersecurity breach prediction application 68 may thus de-escalate, cancel, or even terminate any further inspection, analysis, or review of the cybersecurity detection 34 and its associated computer activities/behaviors/contexts 40/42/44. The server 26/60, and the cybersecurity service 30, may thus reallocate processor, memory, and network resources to other tasks.

The false positive cybersecurity detections 52 greatly waste resources. The cybersecurity service 30 dedicates and prioritizes much hardware (e.g., processor and memory) and network resources to analyzing the cybersecurity detections 34. The cybersecurity service 30 also consumes much electrical power when analyzing the cybersecurity detections 34. When many of the cybersecurity detections 34, though, are determined to be normal operation 50, the cybersecurity service 30 has thus wasted hardware, network, and power resources on the false positive cybersecurity detections 52. Wrong security alerts triggered by benign metadata and other computer activities/behaviors/contexts 40/42/44 are thus a concern in the security industry.

The digital/binary cybersecurity services 30 and/or 62 improve computer functioning. The digital/binary cybersecurity services 30 and/or 62 predicts which cybersecurity detections 34 are the false positive cybersecurity detections 52, before the cloud computing environment 24 (illustrated in FIG. 1) expends significant resources. The digital/binary cybersecurity services 30 and/or 62 preliminarily screen and a priori predict the false positive cybersecurity detections 52. The digital/binary cybersecurity services 30 and/or 62 may also utilize the false positive pruning operation 130 to compensate for the false positive cybersecurity detections 52, thereby more accurately defining the true positive cybersecurity detection characteristics 160. The digital/binary cybersecurity services 30 and/or 62 may thus quickly predict the false positive cybersecurity detections 52, thus greatly reducing the number of the cybersecurity detections 34 that waste hardware, network, and power resources. Moreover, the cybersecurity services 30 and/or 62 more accurately predict and the true positive cybersecurity detections 48 that indicate the cybersecurity breaches 20. The cybersecurity services 30 and/or 62 improve computer functioning.

Computer functioning is further improved. Conventional breach-detection schemes utilize rules-based, or machine-learned based, anomaly detections. Rules-based approaches cannot contextualize normal verses abnormal behavior for each individual user/device/entity. The conventional anomaly-detection schemes focus on single event-level information, which is very inaccurate and results in high false-positive rates. The cybersecurity services 30 and/or 62, instead, cause the computer system 22 (such as the server 26/60) to implement the false pruning operation 130 that prunes the affects or contributions of the false positive cybersecurity detections 52. The computer system 22, for example, aggregates and drops the false positive cybersecurity detection characteristics 162. The computer system 22, and/or the cloud computing environment 24, may use the machine learning model 88 to generate the true positive cybersecurity breach detection profile 170 and to predict the true positive cybersecurity detections 48. The computer system 22 thus more accurately identifies each device's/user's/group's/entity's true positive computer activities/behaviors/contexts 40/42/44 and/or the true positive cybersecurity detection characteristics 162. The computer system 22 more accurately identifies the abnormal operation 46, meaning suspicious/malicious usage is more quickly identified and resolved. The computer system 22 protects client devices, cloud services, and/or the cloud computing environment 24 from cyber threats.

Computer functioning is further improved. The false positive cybersecurity detections 52 greatly waste resources (as previously explained). The cybersecurity services 30 and/or 62, though, greatly reduce and conserve hardware (e.g., processor and memory) and network resources. By predicting the false positive cybersecurity detections 52, processor cycles are reduced/eliminated and much memory bytes are conserved. Network packet traffic is greatly reduced, as the predicted false positive cybersecurity detections 52 may be immediately/initially dropped from further analysis. Moreover, by more accurately defining the true positive cybersecurity breach detection profile 170, the cybersecurity breaches 20 are more quickly and more accurately determined. Simply put, substantial computer resources may be reduced and reallocated, and substantial electrical power is concomitantly conserved.

FIGS. 23-25 illustrate examples of detection sourcing. The computer system 22 (again illustrated as the server 26) receives the cybersecurity detection 34. While the cybersecurity detection 34 may be sent or retrieved from the cloud computing network 24, the cybersecurity detection 34 may originate from the client device 36 (perhaps subscribing to the cybersecurity services 30 and/or 62). The client device 36 has a hardware processor that executes an operating system stored in a local memory device (all not shown for simplicity). The client device 36 stores many software applications 190 that are executed by its hardware processor. Some of the software applications 190, for example, represent an endpoint cybersecurity agent 192. The endpoint cybersecurity agent 192 has instructions or code that interface with the client's operating system and/or with the software applications 190. The endpoint cybersecurity agent 192 thus senses and monitors events, operations, processes, and other computer activities/behaviors/contexts 40/42/44 conducted by the client device 36. As the client device's hardware processor executes the software applications 190, any of the software applications 190 may attempt to maliciously affect the client device 36. When the endpoint cybersecurity agent 192 detects suspicious or unknown computer activities/behaviors/contexts 40/42/44, the endpoint cybersecurity agent 192 generates and sends the cybersecurity detection 34 via a communications network (not shown for simplicity) to an IP address associated with the cybersecurity services 30/62. When the cloud computing environment 24 receives the cybersecurity detection 34, the networked members 28 of the cloud computing environment 24 may route the cybersecurity detection 34 to the server 26 for the fast and elegant cybersecurity services 30 and/or 62. If the false positive cybersecurity detection 52 is predicted, then perhaps the endpoint cybersecurity agent 192 is authorized to approve/allow the computer activities/behaviors/contexts 40/42/44. If, however, the true positive cybersecurity detection 48 is predicted, the cloud computing environment 24 may instruct the endpoint cybersecurity agent 192 to deny or terminate the computer activities/behaviors/contexts 40/42/44. The cloud computing environment 24 and/or the endpoint cybersecurity agent 192 may also cause the software application(s) 190 to terminate.

The cybersecurity services 30 and/or 62 may thus implement entity and event pruning with machine learning. The cybersecurity services 30 and/or 62 refine the integrity of graph entities by eliminating irrelevant or misleading elements from the multi-layered graph. The cybersecurity services 30 and/or 62 utilize ML pruning techniques (or a combination of ML techniques) to enhance the graph's utility and the accuracy of subsequent analyses. The cybersecurity services 30 and/or 62 employ anomaly detection algorithms (this includes supervised or unsupervised learning models like clustering and isolation forests) for identifying and removing false positives, significantly reducing the graph's noise level by spotlighting anomalies that diverge from established patterns of normal behavior. To further assess the relevance of the graph's nodes and edges, the cybersecurity services 30 and/or 62 may apply statistical methods (e.g., variance thresholds and correlation coefficients). This helps determine the importance of each connection, ensuring that only the most significant data points are maintained. The cybersecurity services 30 and/or 62 may thus score connections based on various metrics such as the frequency of occurrence, centrality within the graph, or connections to known suspicious entities or behaviors. By leveraging entity relationship scoring and unsupervised anomaly detection, the component effectively filters out low-scoring entities and relationships, which are often indicative of irrelevance or false positives.

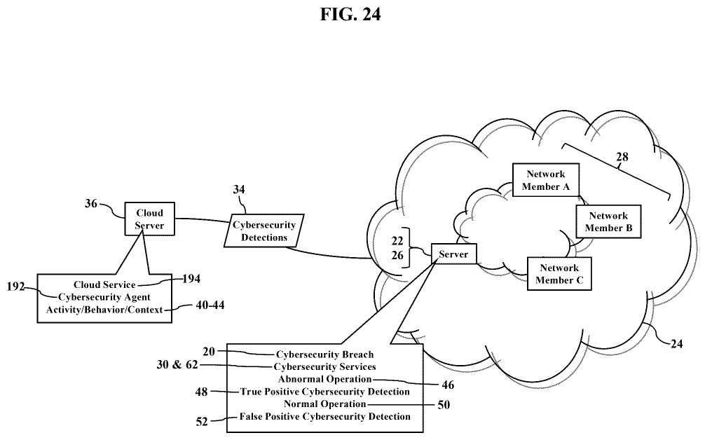

FIG. 24 illustrates examples of cloud sourcing. Here the endpoint cybersecurity agent 192 may monitor a cloud service 194 for suspicious/unknown computer activities/behaviors/contexts 40/42/44. The cloud service 194 is provided on behalf of a cloud service provider. There are many different cloud services 194 and many different cloud service providers. Some cloud service providers include AMAZON AWS^{®}, MICROSOFT AZURE^{®}, GOOGLE CLOUD PLATFORM^{®}, ALIBABA^{®}, IBM CLOUD^{®}, ORACLE CLOUD^{®}, TENCENT CLOUD^{®}, SALESFORCE^{®}, SAP CLOUD^{®}, and VMWARE CLOUD^{®}. Some cloud services include compute services, storage services, database services, networking services, artificial intelligence services, and machine learning services. The endpoint cybersecurity agent 192 may thus be installed to any cloud server as the client device 36 providing at least a portion of the cloud service 194. The endpoint cybersecurity agent 192 monitors events, operations, processes, and other computer activities/behaviors/contexts 40/42/44 associated with the cloud service 194. When the endpoint cybersecurity agent 192 detects suspicious/unknown computer activities/behaviors/contexts 40/42/44, the endpoint cybersecurity agent 192 generates and sends the cybersecurity detection 34 to an IP or other network address associated with the cybersecurity service 30/62. When the cloud computing environment 24 receives the cybersecurity detection 34, the cloud computing environment 24 may route the cybersecurity detection 34 to the server 26 for the cybersecurity services 30 and/or 62. The server 26 may thus receive the cybersecurity detection 34 as a real time, or near real time, monitoring input. If the normal operation 50 (and/or the false positive cybersecurity detection 52) is predicted, then perhaps the endpoint cybersecurity agent 192 is authorized to approve/allow the computer activities/behaviors/contexts 40/42/44. If, however, the abnormal operation 46 is predicted, the cloud computing environment 24 may hand-off the cybersecurity detection 34 to other systems, teams, groups, and/or networked members 28 for a deeper or more sophisticated analysis. The cybersecurity services 30 and/or 62 may have authority to delay the cloud service 194 pending further investigation. The cybersecurity services 30 and/or 62 may have authority to instruct the endpoint cybersecurity agent 192 to deny or terminate the computer activities/behaviors/contexts 40/42/44, and/or the cloud service 194, again perhaps in real time or near real time. The cybersecurity services 30 and/or 62 thus monitor the cloud service 194 and detect/predict false and true positive computer activities/behaviors/contexts 40/42/44 representing a potential cybersecurity breach 20.

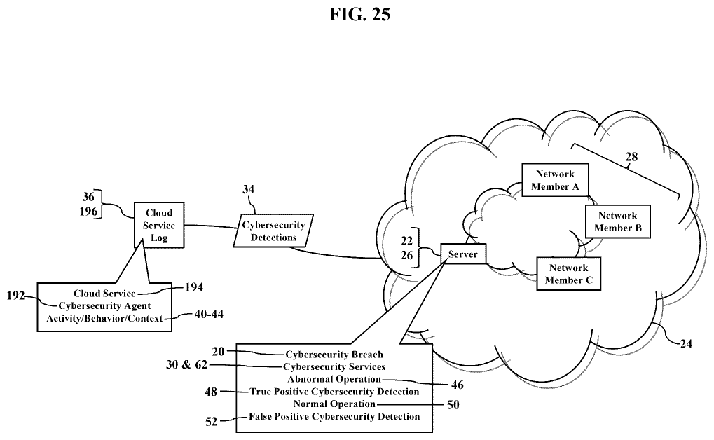

As FIG. 25 illustrates, the cybersecurity services 30 and/or 62 may also interface with cloud logging services. As the cloud service 194 is provided, the cloud service 194 may log and store events associated with the cloud service 194. While other data logging schemes may be used, FIG. 25 illustrates a cloud service log 196. The cloud service log 196 may be a cloud/network database resource that stores service/computer activities/behaviors/contexts 40/42/44 and their corresponding time stamps. The cloud service 194 may thus make the cloud service log 196 available to third parties (such as the cybersecurity services 30 and/or 62). The cybersecurity services 30 and/or 62 may thus interface with the cloud service log 196. The server 26, for example, may query the cloud service log 196 and to retrieve any data logs associated with the cybersecurity detection 34 (again perhaps logged within a window of time). By retrieving the data logs, for example, the false positive prediction service 52 may identify and retrieve a fuller description of the computer activities/behaviors/contexts 40/42/44 surrounding or occurring over any timeframe of the cybersecurity detection 34. Whatever the source of the service/computer activities/behaviors/contexts 40/42/44, the activities/behaviors/contexts 40/42/44 may be used to enrich the cybersecurity services 30/62 and/or the multi-layered graph 82 for the purpose of breach detection.

The cloud service log 196 may thus supplement training data. As this disclosure above explained, the cybersecurity services 30 and/or 62 may extract features that represent the true positive cybersecurity detections 48 and/or the false positive cybersecurity detections 52. While the true/false positive cybersecurity detection characteristics 160/162 (illustrated in FIGS. 15-18) may be retrieved from any network source or service, the true/false positive cybersecurity detection characteristics 160/162 may be retrieved from the cloud service log 196. While other cloud logging services may be used, Amazon's AWS CLOUDTRAIL^{®} service logs actions taken by client devices 36 and any AWS cloud service 194. The AWS CLOUDTRAIL^{®} data, in other words, may be one of the sources for the true/false positive cybersecurity detection characteristics 160/162. Whatever the cloud logging service, though, log data often reveals the true/false positive cybersecurity detection characteristics 160/162 (such as usage patterns, roles, responsibilities, intentions, and context).

The cloud service provider may rely on the cybersecurity services 30 and/or 62. When the cloud service 194 is provided, the cloud service provider needs tools that identify the unusual or abnormal operation 46. Anomalous cloud behavior is often a precursor to identifying malicious behavior and the cybersecurity breaches 20. The cybersecurity services 30 and/or 62 identify the true positive cybersecurity detections 48, and/or the false positive cybersecurity detections 52, generated while providing the cloud service 194. Conventional cybersecurity schemes strive to detect abnormal computer activity, so these conventional cybersecurity schemes generate enormous numbers of false positive reports of malicious behavior. The cybersecurity services 30 and/or 62, in contradistinction, more accurately define the true positive cybersecurity detections 48 and/or the false positive cybersecurity detections 52. Because each user's, and each service's, cloud behavior may be unique and variable, the cybersecurity services 30 and/or 62 learn from the usage patterns and behavior represented by previous/historical/current cybersecurity detections 34. The cybersecurity services 30 and/or 62 capture and refine the true positive cybersecurity detection characteristics 160 by predicting and pruning the false positive cybersecurity detections 162.

The cybersecurity services 30 and/or 62 may integrate statistical context into the machine learning model 88. Because the machine learning model 88 may be trained using the graphical data 92, the cybersecurity services 30 and/or 62 may utilize graph machine learning (or graph ML). The cybersecurity services 30 and/or 62, for example, apply graph ML (such as GCN, GNN, or other supervised or semi-supervised algorithm where the cybersecurity prediction 90 may be determined at the nodes 104 or graph level) on the graphical data 92. The cybersecurity services 30 and/or 62 analyzes the multi-layered attack graph 100, for example, by incorporating the statistical edge weights assigned to the edges 106. These edge weights encode the likelihood of the cybersecurity detection 34 being a false positive based on its characteristics (patterns, prevalence, occurrences, and other false positive cybersecurity detection characteristics 162). This statistical context enhances the graph ML ability to identify high-probability false positives within the user's/customer's environment. Graph ML provides a powerful mechanism for pattern recognition within the graphical data 92 and is excellent at handling the complex structures and relationships represented in the attack graph 100. The graph ML learns from network topology, the nodes 104, node features, the edge weights, and other graphical data 92 to identify patterns indicative of false positive cybersecurity detection characteristics 162.

Conventional cybersecurity schemes require hours, or even days, of analysis. In general, tracking an adversary through a user's or company's network infrastructure, analyzing an active breach, and generating accurate and meaningful XDR detections (or incidents) is a complex and challenging task. Cyber breaches have evolved to become highly sophisticated, often utilizing advanced techniques that easily evade conventional security measures. Cyber attackers use a wide range of attack vectors (such as phishing emails, malicious attachments, drive-by downloads, and supply chain attacks) that require unique detection mechanisms. Attackers continuously adapt and change to avoid detection. Modern organizations generate massive amounts of IT data that must be processed and analyzed to identify meaningful patterns and anomalies. Threat analysts thus face the burden of manually analyzing a vast amount of event data from various sources to identify potential threats. Conventional cybersecurity schemes are thus time-consuming and may require hours (or even days) to build a full picture of what occurred.

The cybersecurity services 30 and/or 62, though, compress hours, or even days, of analysis into minutes. The cybersecurity services 30 and/or 62 may be performed within minutes of receipt of the cybersecurity detection 34. The cybersecurity services 30 and/or 62 detects novel lateral movement, explains the cybersecurity detection 34, and generates a summary of the cybersecurity breach 20. The graphical data 92 (and thus the attack graph 100), for example, accelerates analysis and builds a rich corpus of cybersecurity data (such as the graphical data 92). The abnormal operation 48 is far more accurately described by pruning the false positive cybersecurity detections 52.

The cybersecurity services 30 and/or 62 may generate the attack graph 100 for display. The graphical data 92 (visually presented as the attack graph 100) represents all possible paths of an attack against the client device 36, a computer network, the cloud service 194, and other customer/client computer/network environments. The attack graph 100, for example, helps security teams understand the timeline of an attack, the compromised hosts and users, relationships between various assets in the customer environment, and how they may be vulnerable to an attack. The attack graph 100 shows all assets compromised by an adversary, incidents in progress, and detects an attack in progress. The attack graph 100 also maps out all of the possible paths that an attacker could take to compromise a particular asset or set of assets in an environment. The attack graph 100 takes into account the different attack vectors that could be used and heuristically identifies lateral movement, C2 communication, and data exfiltration techniques. The attack graph 100 scales to handle a large amount of data and quickly visualizes the full timeline and related entities of an attack by connecting suspicious entities with the related assets (such as users, devices, and applications). The attack graph 100 identifies novel intrusions and provides comprehensive and contextual understanding of a security incident as well as serves as a unified view of all events, indicators, and entities involved in an attack. The attack graph 100 automatically correlates events from multiple sources to identify a complete chain of events. The attack graph 100 identifies the root cause of an incident and visualizes complex relationships between events and entities. Adversaries may be tracked across entire company infrastructure and pieces together a series of events to make sense of how a breach was executed and what assets were compromised. The cybersecurity services 30 and/or 62 thus self-discover incidents (such as the true positive cybersecurity detections 48) that warrant investigation without requiring a manual trigger. The cybersecurity services 30 and/or 62 thus more accurately provide early warnings of emerging attacks.

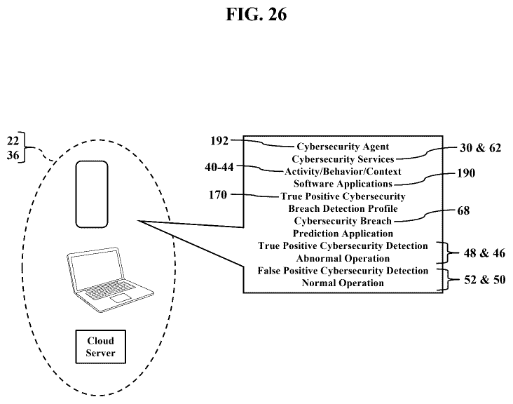

FIG. 26 illustrates examples of local endpoint prediction. Here the endpoint cybersecurity agent 192 may also provide the cybersecurity services 30 and/or 62. The endpoint cybersecurity agent 192 may cooperate with the local host operating system to monitor the computer system 22 (such as the client device 36). The client device's operating system notifies the endpoint cybersecurity agent 192 of events, processes, API calls, machine data, and other computer activities/behaviors/contexts 40/42/44 requested by the locally-stored software applications 190. The endpoint cybersecurity agent 192 may then compare the computer activities/behaviors/contexts 40/42/44 to the true positive cybersecurity breach detection profile 170. Here, though, some or all of the true positive cybersecurity breach detection profile 170 may be locally stored in the client device's local memory device (not shown for simplicity). The true positive cybersecurity breach detection profile 170, for example, may be locally generated and trained by the endpoint cybersecurity agent 192. The true positive cybersecurity breach detection profile 170, however, may additionally or alternatively be generated and pre-trained by the cloud computing network 24 (illustrated in FIG. 1) and distributed to clients in the field. The endpoint cybersecurity agent 192 may incorporate the cybersecurity breach prediction application 68 as a module and locally generate the cybersecurity breach prediction 90. If the true positive cybersecurity detection 48 is predicted, then the computer activities/behaviors/contexts 40/42/44 represents the abnormal operation 46. The endpoint cybersecurity agent 192 may generate and display/send warnings or other notifications. The endpoint cybersecurity agent 192 may also deny/halt/terminate the computer activities/behaviors/contexts 40/42/44 representing the abnormal operation 46. The endpoint cybersecurity agent 192 may also cause the software application(s) 180 to terminate. If, however, the false positive cybersecurity detection 52 is predicted, then the computer activities/behaviors/contexts 40/42/44 represent the normal operation 50. The endpoint cybersecurity agent 192 may thus allow, authorize, or approve the computer activities/behaviors/contexts 40/42/44.

The endpoint cybersecurity agent 192 may be an antimalware driver. The endpoint cybersecurity agent 192, for example, may have kernel-level components having kernel-level permissions to a kernel of the host client device's operating system. The endpoint cybersecurity agent 192 may additionally have user-mode components having user-level permissions to a user mode of the host client device's operating system. The endpoint cybersecurity agent 192 may include computer program, code, or instructions that scan and monitor the host client device's operating system for events, communications, processes, activities, behaviors, data values, usernames/logins, locations, contexts, and/or patterns. Because the endpoint cybersecurity agent 192 has kernel-level permissions, the endpoint cybersecurity agent 192 may monitor any kernel-level activity and/or any user-mode activity conducted by the client device 36. The endpoint cybersecurity agent 192 may register for and receive kernel-level notifications and call backs from the kernel.

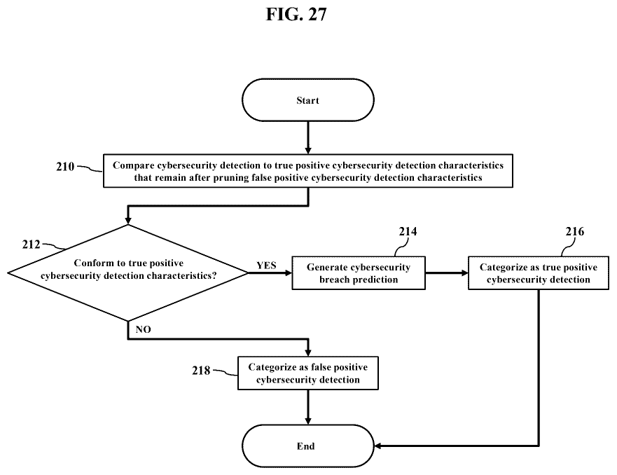

FIG. 27 illustrates examples of methods or operations that generate the cybersecurity breach prediction 90. The cybersecurity detection 34 is compared to the true positive cybersecurity detection characteristics 160 that remain after having pruned therefrom the false positive cybersecurity detection characteristics 162 (Block 210). If the cybersecurity detection 34 conforms to the true positive cybersecurity detection characteristics 160 (Block 212), then generate the cybersecurity breach prediction 90 (Block 214) and categorize the cybersecurity detection 34 as the true positive cybersecurity detection 48 (Block 216). If, however, the cybersecurity detection 34 fails to conform to the true positive cybersecurity detection characteristics 160 (Block 212), categorize the cybersecurity detection 34 as the false positive cybersecurity detection 52 (Block 218).

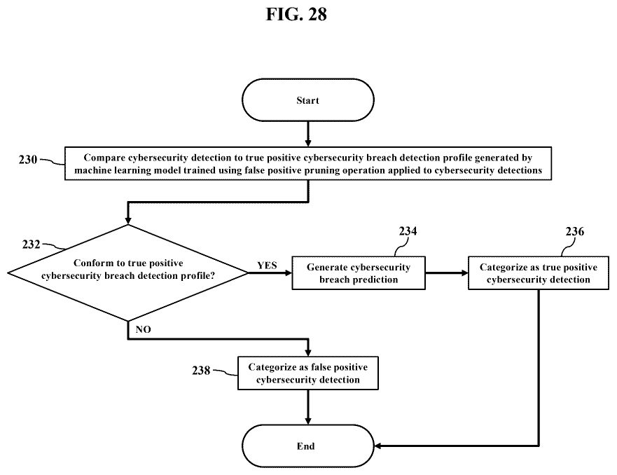

FIG. 28 illustrates more examples of methods or operations that generate the cybersecurity breach prediction 90. The cybersecurity detection 34 is compared to the true positive cybersecurity breach detection profile 170 generated by the machine learning model 88 trained using the false positive pruning operation 130 applied to the cybersecurity detections 34 (Block 230). If the cybersecurity detection 34 conforms to the true positive cybersecurity breach detection profile 170 (Block 232), then generate the cybersecurity breach prediction 90 (Block 234) and categorize the cybersecurity detection 34 as the true positive cybersecurity detection 48 (Block 236). If, however, the cybersecurity detection 34 fails to conform to the true positive cybersecurity breach detection profile 170 (Block 232), categorize the cybersecurity detection 34 as the false positive cybersecurity detection 52 (Block 238).

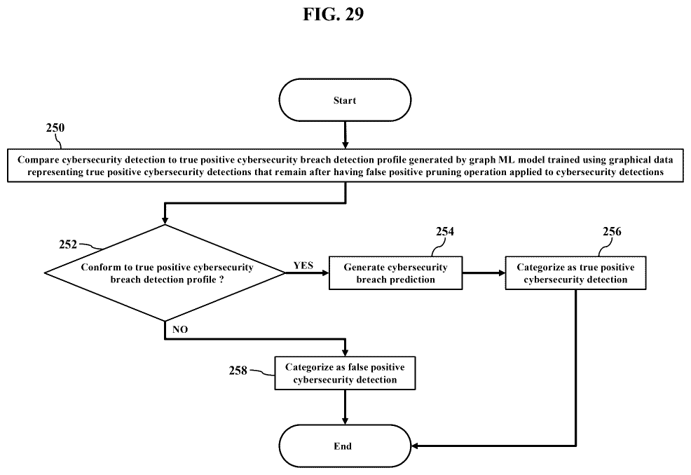

FIG. 29 illustrated more examples of methods or operations that generate the cybersecurity breach prediction 90. The cybersecurity detection 34 is compared to the true positive cybersecurity breach detection profile 170 generated by the graph machine learning model 88 trained using the graphical data 92 representing the true positive cybersecurity detections 48 that remain after having the false positive pruning operation 130 applied to the cybersecurity detections 34 (Block 250). If the cybersecurity detection 34 conforms to the true positive cybersecurity breach detection profile 170 (Block 252), then generate the cybersecurity breach prediction 90 (Block 254) and categorize the cybersecurity detection 34 as the true positive cybersecurity detection 48 (Block 256). If, however, the cybersecurity detection 34 fails to conform to the true positive cybersecurity breach detection profile 170 (Block 252), categorize the cybersecurity detection 34 as the false positive cybersecurity detection 52 (Block 258).

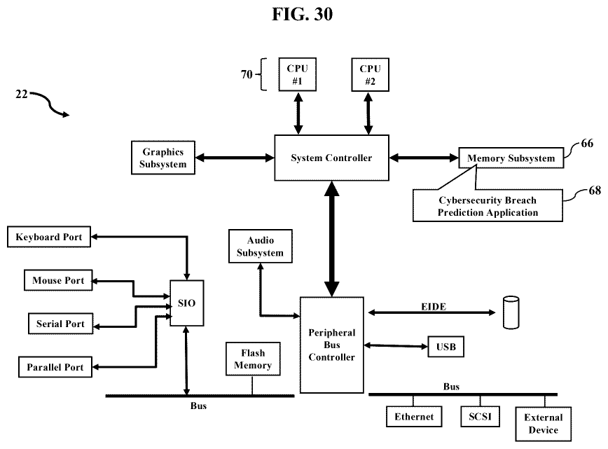

FIG. 30 illustrates a more detailed example of the operating environment. FIG. 30 is a more detailed block diagram illustrating the computer system 22. The cybersecurity breach prediction application 68 is stored in the memory subsystem or device 66. One or more of the hardware processors 70 communicate with the memory subsystem or device 66 and execute the cybersecurity breach prediction application 68. Examples of the memory subsystem or device 66 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 22 may have any embodiment. This disclosure mostly discusses the computer system 22 as the server 26 and the client device 36. The cybersecurity services 30 and 62, however, may be easily adapted to mobile computing, wherein the computer system 22 may be a smartphone, laptop or desktop computer, a switch/router, a tablet computer, or a smartwatch. The cybersecurity services 30 and 62 may also be easily adapted to other embodiments of smart devices, such as a television, an audio device, a remote control, and a recorder. The cybersecurity services 30 and 62 may also be easily adapted to still more smart appliances, such as washers, dryers, and refrigerators. Indeed, as cars, trucks, and other vehicles grow in electronic usage and in processing power, the cybersecurity services 30 and 62 may be easily incorporated into any vehicular controller.

The above examples of the cybersecurity services 30 and 62 may be applied regardless of communications networking technology and networking environment. The cybersecurity services 30 and 62 may be easily adapted to stationary or mobile devices having wide-area networking (e.g., 4G/LTE/5G/6G cellular), wireless local area networking (WI-FI^{®}), near field, and/or BLUETOOTH^{®} capability. The cybersecurity services 30 and 62 may be applied to stationary or mobile devices utilizing any portion of the electromagnetic spectrum and any signaling standard (such as the IEEE 802 family of standards, GSM/CDMA/TDMA or any cellular standard, and/or the ISM band). The cybersecurity services 30 and 62, however, may be applied to any processor-controlled device operating in the radio-frequency domain and/or the Internet Protocol (IP) domain. The cybersecurity services 30 and 62 may be applied to any processor-controlled device utilizing a distributed computing network, such as the Internet (sometimes alternatively known as the “World Wide Web”), an intranet, a local-area network (LAN), and/or a wide-area network (WAN). The cybersecurity services 30 and 62 may be applied to any processor-controlled device utilizing power line technologies, in which signals are communicated via electrical wiring. Indeed, the many examples may be applied regardless of physical componentry, physical configuration, or communications standard(s).

Operating environments may utilize any processing component, configuration, or system. For example, the cybersecurity services 30 and 62 may be easily adapted to execute by a desktop, mobile, or server central/graphical processing unit 70 or chipset offered by INTEL^{®}, ADVANCED MICRO DEVICES^{®}, ARM^{®}, APPLE^{®}, TAIWAN SEMICONDUCTOR MANUFACTURING^{®}, QUALCOMM^{®}, or other manufacturer. The computer system 22 may even use multiple central CPUs/GPUs/cores or chipsets, which could include distributed processors or parallel processors in a single machine or multiple machines. The CPUs/GPUs/cores or chipsets can be used in supporting a virtual processing environment. The CPUs/GPUs/cores or chipsets could include a state machine or logic controller. When any of the CPUs/GPUs/cores or chipsets execute instructions to perform “operations,” this could include the CPUs/GPUs/cores or chipsets performing the operations directly and/or facilitating, directing, or cooperating with another device or component to perform the operations.

The cybersecurity services 30 and 62 may use packetized communications. When the computer system 22 and the cloud computing environment 24 communicate, information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The cybersecurity services 30 and 62 may utilize any signaling standard. The cloud computing environment 24 may mostly use wired networks to interconnect the network members 28. However, the cloud computing environment 24 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 24 may also utilize other standards, such as the I.E.E.E. 802 family of standards, the Industrial, Scientific, and Medical band of the electromagnetic spectrum, BLUETOOTH^{®}, low-power or near-field, and any other standard or value.

The cybersecurity services 30 and 62 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for generating the cybersecurity breach prediction 90, as the above paragraphs explain.

The diagrams, schematics, illustrations, and tables represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that generates a cybersecurity breach prediction, comprising:
comparing, by the computer system, a cybersecurity detection to true positive cybersecurity detection characteristics that remain after having pruned therefrom false positive cybersecurity detection characteristics; and
generating, by the computer system, the cybersecurity breach prediction associated with the cybersecurity detection based on the comparing of the cybersecurity detection to the true positive cybersecurity detection characteristics that remain after having pruned therefrom the false positive cybersecurity detection characteristics.

2. The method of claim 1, further comprising determining the cybersecurity detection conforms to the true positive cybersecurity detection characteristics.

3. The method of claim 2, wherein in response to the determining that the cybersecurity detection conforms to the true positive cybersecurity detection characteristics, further comprising generating an alert that represents the cybersecurity breach prediction.

4. The method of claim 1, further comprising determining the cybersecurity detection fails to conform to the true positive cybersecurity detection characteristics.

5. The method of claim 4, wherein in response to the determining that the cybersecurity detection fails to conform to the true positive cybersecurity detection characteristics, further comprising categorizing the cybersecurity detection as a false positive cybersecurity detection.

6. At least one computer system that generates a cybersecurity breach prediction, comprising:
at least one central processing unit; and
at least one memory device storing instructions that, when executed by the at least one central processing unit, perform operations, the operations comprising:
comparing a cybersecurity detection to a true positive cybersecurity breach detection profile generated by a machine learning model trained using a false positive pruning operation applied to cybersecurity detections; and
generating the cybersecurity breach prediction based on the comparing of the cybersecurity detection to the true positive cybersecurity breach detection profile generated by the machine learning model trained using the false positive pruning operation applied to the cybersecurity detections.

7. The at least one computer system of claim 6, wherein the operations further comprise grouping false positive cybersecurity detections based on similarity.

8. The at least one computer system of claim 7, wherein the operations further comprise pruning a false positive similarity cluster representing the false positive cybersecurity detections.

9. The at least one computer system of claim 6, wherein the operations further comprise grouping false positive cybersecurity detections based on centrality.

10. The at least one computer system of claim 6, wherein the operations further comprise isolating false positive cybersecurity detections.

11. The at least one computer system of claim 6, wherein the operations further comprise determining the cybersecurity detection conforms to the true positive cybersecurity breach detection profile.

12. The at least one computer system of claim 7, wherein the operations further comprise categorizing the cybersecurity detection as true positive.

13. The at least one computer system of claim 7, wherein the operations further comprise generating an alert that represents the cybersecurity breach prediction.

14. The at least one computer system of claim 6, wherein the operations further comprise determining the cybersecurity detection fails to conform to the true positive cybersecurity breach detection profile.

15. The at least one computer system of claim 10, wherein the operations further comprise categorizing the cybersecurity detection as false positive.

16. A memory device storing instructions that, when executed by at least one central processing unit, perform operations that generate a cybersecurity breach prediction, the operations comprising:
comparing a cybersecurity detection to a true positive cybersecurity detection profile generated by a graph machine learning model trained using graphical data representing true positive cybersecurity detections that remain after having a false positive pruning operation applied to cybersecurity detections; and
generating the cybersecurity breach prediction based on the comparing of the cybersecurity detection to the true positive cybersecurity detection profile generated by the graph machine learning model trained using the graphical data representing the true positive cybersecurity detections that remain after having the false positive pruning operation applied to the cybersecurity detections.

17. The memory device of claim 16, wherein the operations further comprise grouping false positive cybersecurity detections based on similarity.

18. The memory device of claim 16, wherein the operations further comprise pruning a false positive similarity cluster from the graphical data, the false positive similarity cluster representing the false positive cybersecurity detections grouped based on the similarity.

19. The memory device of claim 16, wherein the operations further comprise grouping false positive cybersecurity detections based on similarity.

20. The memory device of claim 16, wherein the operations further comprise grouping false positive cybersecurity detections based on centrality.
